(19) United States
(12) Patent Application Publication
(10) Pub. No.: US 2016/0009999 A1
(43) Pub. Date: Jan. 14, 2016

(54) NEMATIC LIQUID CRYSTAL COMPOSITION AND LIQUID CRYSTAL DEVICE USING THE SAME

(71) Applicant: DIC CORPORATION, Itabashi-ku, Tokyo (JP)

(72) Inventors: Shinichi Hirata, Kita-adachi-gun (JP); Takeshi Kuriyama, Kita-adachi-gun (JP); Shotaro Kawakami, Kita-adachi-gun (JP)

(73) Assignee: DIC CORPORATION, Tokyo (JP)

(21) Appl. No.: 14/771,954

(22) PCT Filed: Mar. 4, 2014
(86) PCT No.: PCT/JP2014/055460

§ 371 Date: Sep. 1, 2015

(30) Foreign Application Priority Data
Mar. 6, 2013 (JP) 2013-043987

(51) Int. Cl. C09K 19/56; C09K 19/30

(52) U.S. Cl. CPC C09K 19/56; C09K 19/3066

(57) ABSTRACT

There are provided a polymerizable-compound-containing nematic liquid crystal composition which is useful as a material for a liquid crystal display and which has a negative dielectric anisotropy (Δ∈), and a liquid crystal display device using such a nematic liquid crystal composition. The polymerizable compound is polymerized without interference with generation of the pretilt angle of the liquid crystal molecules by exposure to ultraviolet in a process for producing a device, so that a PSA display device in which a proper pretilt angle is given and which has well stabilized alignment state, a high response speed, and excellent display quality with defective display being eliminated or reduced can be produced. A liquid crystal display device using the liquid crystal composition is useful as an active-matrix liquid crystal display device and can be applied to PSVA liquid crystal display devices.

### TECHNICAL FIELD

The present invention relates to a nematic liquid crystal composition which is useful as a material for a liquid crystal display and which has a negative dielectric anisotropy (Δ∈), and the present invention also relates to a liquid crystal display device using such a nematic liquid crystal composition.

### BACKGROUND ART

Liquid crystal display devices are applied to, for example, watches, calculators, a variety of household electrical appliances, measuring equipment, panels used in automobiles, word processors, electronic notebooks, printers, computers, and television sets. Representative examples of types of liquid crystal display devices include a TN (twisted nematic) type, an STN (super twisted nematic) type, a DS (dynamic scattering) type, a GH (guest-host) type, an IPS (in-plane switching) type, an OCB (optically compensated birefringence) type, an ECB (electrically controlled birefringence) type, a VA (vertical alignment) type, a CSH (color super homeotropic) type, and an FLC (ferroelectric liquid crystal) type. Examples of a drive system include static driving, multiplex driving, a passive matrix, and an active matrix (AM) in which, for example, a TFT (thin film transistor) or a TFD (thin film diode) is used for driving.

Among these types of liquid crystal display devices, an IPS type, an ECB type, a VA type, and a CSH type are characterized in that a liquid crystal material having a negative Δ∈ is used. In particular, VA display devices of AM driving are applied to display devices that need to quickly respond and to have a wide viewing angle, such as television sets.

Nematic liquid crystal compositions used in, for instance, VA display devices need to enable driving at low voltage, a quick response, and a broad range of operating temperature. In other words, a liquid crystal composition having a negative Δ∈ with a large absolute value, low viscosity, and a high nematic phase-isotropic liquid phase transition temperature (Tₙᵢ) has been demanded. In order to control Δn×d that is a product of refractive index anisotropy (Δn) and a cell gap (d) to be a predetermined value, the Δn of a liquid crystal material needs to be adjusted to be in a proper range on the basis of the cell gap. In addition, a quick response is important in liquid crystal display devices applied to television sets or other apparatuses, which generates a need for a liquid crystal material having a small viscosity (η).

A variety of compounds having a negative Δ∈ with a large absolute value have been studied to improve the properties of liquid crystal compositions.

A liquid crystal composition containing the following liquid crystal compounds (A) and (B) each having a 2,3-difluorophenylene structure has been disclosed as a liquid crystal material having a negative Δ∈ (see Patent Literature 1).

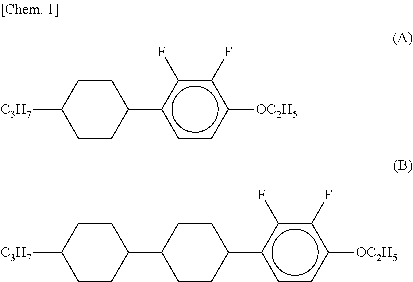

This liquid crystal composition also contains liquid crystal compounds (C) and (D) as compounds having a Δ∈ of substantially zero; however, the liquid crystal composition does not have a sufficiently low viscosity that is necessary in applications in which a quick response is needed, such as liquid crystal television sets.

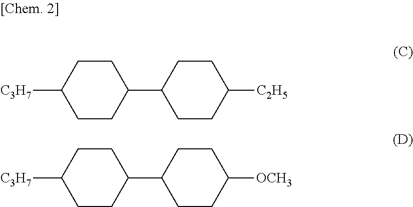

Another liquid crystal composition has been disclosed, in which a compound represented by Formula (E) is used at a concentration of not less than 30% to enhance response speed (see Patent Literature 2).

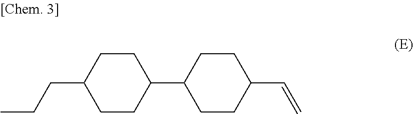 [SMILES: C=CC1CCC(C2CCC(CCC)CC2)CC1]

One of known VA display devices is a PSA (Polymer Sustained Alignment) liquid crystal display device. This type of display device has a structure in which objects made of a polymer are disposed in the liquid crystal cell in order to control the pretilt angle of liquid crystal molecules, so that it has a high response speed and high contrast; hence, development of such a liquid crystal display device has been promoted.

In production of a PSA liquid crystal display device, a polymerizable-compound-containing liquid crystal composition that contains a polymerizable compound and a liquid crystal compound is put between substrates, voltage is applied to align liquid crystal molecules, and the polymerizable compound is polymerized in this state to fix the alignment of the liquid crystal molecules.

In production of PSA liquid crystal display device, a polymerizable-compound-containing liquid crystal composition that contains a polymerizable compound and a liquid crystal compound is put between substrates, voltage is applied to align liquid crystal molecules, and the polymerizable compound is polymerized in this state to fix the alignment of the liquid crystal molecules.

PSA liquid crystal display devices have a problem of, for instance, the occurrence of defective display such as screen burn-in. It is known that screen burn-in is caused by impurities and a change in the alignment of liquid crystal molecules with time (change in a pretilt angle with time). The change in a pretilt angle is caused as follows: if a polymer as a cured polymerizable compound is soft, the structure of the polymer is changed in a liquid crystal display device on which a fixed pattern has been displayed for a long time with the result that the pretilt angle is changed in some cases. In order to solve this problem, a PSA display device using a polymerizable compound having a structure such as a 1,4-phenylene group (see Patent Literature 3) and a PSA display device using a polymerizable compound having a biaryl structure (see Patent Literature 4) have been studied. Furthermore, a composition used in PSA display devices has been disclosed (see Patent Literature 5).

In PSA display devices having useful display properties (contrast and response speed), the problem of defective display involved with alignment of liquid crystal molecules has been studied in an attempt to be solved by optimization of a polymerizable compound as described above; however, use of some compounds is unsuitable in a PSA display device depending on the components of a liquid crystal composition used therein. In particular, a liquid crystal composition containing a liquid crystal material that has an alkenyl group and that is thus effective in decreasing the viscosity is helpful in decreasing the response speed of VA display devices but has another problem in alignment control, in which development of the pretilt angle of the liquid crystal molecules is inhibited after polymerization of a polymerizable compound in a process for producing PSA display devices. In the case where liquid crystal molecules are not given a proper pretilt angle, a direction in which the liquid crystal molecules move at driving cannot be defined, which results in problems in which the liquid crystal molecules are not inclined in a predetermined direction with the result that contrast is impaired and in which a response speed is decreased.

Moreover, another technique has been disclosed in Patent Literature 6, in which a liquid crystal material having a large index represented by (Equation 1) is used to enhance the response speed of a homeotropic liquid crystal cell; however, the enhancement in a response speed is insufficient.

[Math. 1]

FoM=K₃₃·Δn²/γ1 (Equation 1)
K₃₃: Elastic constant
Δn: Refractive index anisotropy
γ1: Rotational viscosity

Accordingly, a liquid crystal composition needs to have properties such as enabling high contrast and quick response and having a high voltage holding ratio, which are necessary in vertical-alignment display devices such as VA display devices, and also to satisfy requirements of generating a proper pretilt angle and enabling the continuous stability of the pretilt angle, which are necessary in PSA display devices.

### CITATION LIST

### Patent Literature

PTL 1: Japanese Unexamined Patent Application Publication No. 8-104869
PTL 2: Japanese Unexamined Patent Application Publication (Translation of PCT Application) No. 2009-504814
PTL 3: Japanese Unexamined Patent Application Publication No. 2003-307720
PTL 4: Japanese Unexamined Patent Application Publication No. 2008-116931
PTL 5: WO 2010/084823
PTL 6: Japanese Unexamined Patent Application Publication No. 2006-301643

### SUMMARY OF INVENTION

### Technical Problem

It is an object of the present invention to provide a liquid crystal composition having the following properties without reductions in refractive index anisotropy (Δn) and nematic phase-isotropic liquid phase transition temperature (Tₙᵢ): sufficiently small viscosity (η), sufficiently small rotational viscosity (γ₁), a large elastic constant (K33), stably high specific resistance and voltage holding ratio, and successful polymerization of a polymerizable compound without interference with generation of the pretilt angle of liquid crystal molecules by exposure to ultraviolet in a process for producing a PSA display device. It is another object of the present invention to provide a PSA liquid crystal display device that uses such a liquid crystal composition to properly develop a pretilt angle and that has well stabilized alignment state, a high response speed, and excellent display quality with defective display being eliminated or reduced.

### Solution to Problem

The inventor has studied a variety of compounds and found that a combination of specific compounds in predetermined amounts enables the above-mentioned objects to be achieved, thereby accomplishing the present invention.

The present invention provides a liquid crystal composition containing a first component that is 5 mass % to 25 mass % of a compound represented by Formula (I),

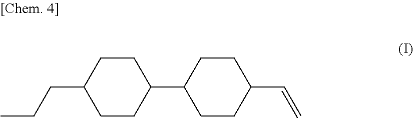 [SMILES: C=CC1CCC(C2CCC(CCC)CC2)CC1]

a second component that is at least one compound having a negative dielectric anisotropy (Δ∈) with an absolute value of greater than three and a structure represented by any of General Formulae (Ia) to (Ic)

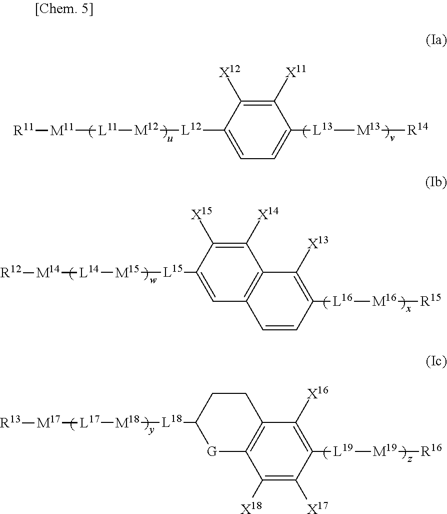

(where R¹¹, R¹², R¹³, R¹⁴, R¹⁵, and R¹⁶ each independently represent an alkyl group having 1 to 10 carbon atoms or an alkenyl group having 2 to 10 carbon atoms; in each of the alkyl and alkenyl groups, one methylene group or at least two methylene groups not adjoining each other are each independently optionally substituted with —O— or —S—, and at least one hydrogen atom is optionally substituted with a fluorine atom or a chlorine atom;

u, v, w, x, y, and z each independently represent 0, 1, or 2 where u+v, w+x, and y+z are each equal to 2 or lower;
M¹¹, M¹², M¹³, M¹⁴, M¹⁵, M¹⁶, M¹⁷, M¹⁸, and M¹⁹ each independently represent a group selected from the group consisting of
(a) a trans-1,4-cyclohexylene group (of which one methylene group or at least two methylene groups not adjoining each other are optionally substituted with —O— or —S—),
(b) a 1,4-phenylene group (of which one —CH═ moiety or at least two —CH═ moieties not adjoining each other are each optionally substituted with a nitrogen atoms), and
(c) a 1,4-cyclohexenylene group, a 1,4-bicyclo(2.2.2)octylene group, a piperidine-2,5-diyl group, a naphthalene-2,6-diyl group, a 1,2,3,4-tetrahydronaphthalene-2,6-diyl group, and a decahydronaphthalene-2,6-diyl group; in each of the groups (a), (b), and (c), a hydrogen atom is optionally substituted with a cyano group, a fluorine atom, a trifluoromethyl group, a trifluoromethoxy group, or a chlorine atom; in the case where M¹², M¹³, M¹⁵, M¹⁶, M⁸, and M¹⁹ are multiple, the multiple M¹²'s, M¹³'s, M¹⁵'s, M¹⁶'s, M¹⁸'s, and M¹⁹'s may be individually the same as or different from each other;
L¹¹, L¹², L¹³, L¹⁴, L¹⁵, L¹⁶, L¹⁷, L¹⁸, and L¹⁹ each independently represent a single bond, —COO—, —OCO—, —CH₂CH₂—, —(CH₂)⁴—, —OCH₂—, —CH₂O—, —OCF₂—, —CF₂O—, or —C≡C—; in the case where L¹¹, L¹³, L¹⁴, L¹⁶, and L¹⁷, and are multiple, the multiple L¹¹'s, L¹³'s, L¹⁴'s, L¹⁶'s, L¹⁷'s, and L¹⁹'s may be individually the same as or different from each other; at least one of L¹¹, L¹², and L¹³ present in the structure does not represent a single bond; at least one of L¹⁴, L¹⁵, and L¹⁶ present in the structure does not represent a single bond; and at least one of L¹⁷, L¹⁸, and L¹⁹ present in the structure does not represent a single bond;
X¹¹ and X¹² each independently represent a trifluoromethyl group, a trifluoromethoxy group, or a fluorine atom; X¹³, X¹⁴, X¹⁵, X¹⁶, X¹⁷, and X¹⁸ each independently represent a hydrogen atom, a trifluoromethyl group, a trifluoromethoxy group, or a fluorine atom; any one of X¹¹ and X¹² represents a fluorine atom; any one of X¹³, X¹⁴, and X¹⁵ represents a fluorine atom; any one of X¹⁶, X¹⁷, and X¹⁸ represents a fluorine atom; each of X¹⁶ and X¹⁷ does not represent a fluorine atom at the same time; each of X¹⁶ and X¹⁸ does not represent a fluorine atom at the same time; and G represents a methylene group or —O—), and
a third component that is at least one polymerizable compound having at least one polymerizable functional group.

The present invention also provides a liquid crystal display device using such a liquid crystal composition.

### Advantageous Effects of Invention

The liquid crystal composition of the present invention has sufficiently small viscosity (η), sufficiently small rotational viscosity (γ1), and a relatively large elastic constant (K33) without reductions in refractive index anisotropy (Δn) and nematic phase-isotropic liquid phase transition temperature (Tₙᵢ) and is free from interference with control of molecular alignment in polymerization of a polymerizable compound contained in the liquid crystal composition; hence, a PVA liquid crystal display device using such a liquid crystal composition has properly controlled molecular alignment, a high response speed, and excellent display quality with defective display being eliminated or reduced.

### DESCRIPTION OF EMBODIMENTS

The liquid crystal composition of the present invention contains a first component that is 5 to 25 mass % of a compound represented by General Formula (I-1); the amount is preferably in the range of 7 to 23 mass %, and especially preferably 10 to 22 mass %.

The liquid crystal composition of the present invention contains a second component that is a compound having a negative dielectric anisotropy (Δ∈) with an absolute value of greater than three.

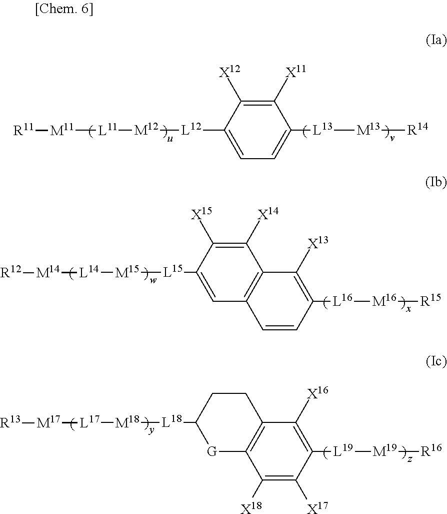

Specific examples of the second component include compounds represented by General Formula (Ib) or (Ic).

In the formulae, R¹¹, R¹², R¹³, R¹⁴, R¹⁵, and R¹⁶ each independently represent an alkyl group having 1 to 10 carbon atoms or an alkenyl group having 2 to 10 carbon atoms; in each of the alkyl and alkenyl groups, one methylene group or at least two methylene groups not adjoining each other are each optionally substituted with —O— or —S—, and at least one hydrogen atom is optionally substituted with a fluorine atom or a chlorine atom. R¹¹, R¹², and R¹³ are each preferably an alkyl group having 1 to 5 carbon atoms, an alkoxyl group having 1 to 5 carbon atoms, an alkenyl group having 2 to 5 carbon atoms, or an alkenyloxy group having 2 to 5 carbon atoms; more preferably an alkyl group having 1 to 5 carbon atoms or an alkenyl group having 2 to 5 carbon atoms; and further preferably an alkyl group having 1 to 3 carbon atoms or an alkenyl group having 3 carbon atoms. R¹⁴, R¹⁵, and R¹⁶ are each preferably an alkyl group having 1 to 5 carbon atoms, an alkoxyl group having 1 to 5 carbon atoms, or an alkenyloxy group having 1 to 5 carbon atoms; and more preferably an alkyl group having 1 or 2 carbon atoms or an alkoxy group having 1 or 2 carbon atoms. u, v, w, x, y, and z each independently represent 0, 1, or 2 where u+v, w+x, and y+z are each equal to 2 or lower.

M¹¹, M¹², M¹³, M¹⁴, M¹⁵, M¹⁶, M¹⁷, M¹⁸, and M¹⁹ each independently represent a group selected from the group consisting of

(a) a trans-1,4-cyclohexylene group (of which one methylene group or at least two methylene groups not adjoining each other are optionally substituted with —O— or —S—);
(b) a 1,4-phenylene group (of which one —CH═ moiety or at least two —CH═ moieties not adjoining each other are each optionally substituted with a nitrogen atom); and
(c) a 1,4-cyclohexenylene group, a 1,4-bicyclo(2.2.2)octylene group, a piperidine-2,5-diyl group, a naphthalene-2,6-diyl group, a 1,2,3,4-tetrahydronaphthalene-2,6-diyl group, and a decahydronaphthalene-2,6-diyl group. In each of the groups (a), (b), and (c), a hydrogen atom is optionally substituted with a cyano group, a fluorine atom, a trifluoromethyl group, a trifluoromethoxy group, or a chlorine atom. In the case where M¹², M¹³, M¹⁵, M¹⁶, M¹⁸, and M¹⁹ are multiple, the multiple M¹²'s, M¹³'s, M¹⁵'s, M¹⁶'s, M¹⁸'s, and M¹⁹'s may be individually the same as or different from each other and are each independently preferably a trans-1,4-cyclohexylene group or a 1,4-phenylene group.

L¹¹, L¹², L¹³, L¹⁴, L¹⁵, L¹⁶, L¹⁷, L¹⁸, and L¹⁹ each independently represent a single bond, —COO—, —OCO—, —CH₂CH₂—, —(CH₂)₄—, —OCH₂—, —CH₂O—, —OCF₂—, —CF₂O—, or —C≡C—. In the case where L¹¹, L¹³, L¹⁴, L¹⁶, L¹⁷, and L¹⁹ are multiple, they may be individually the same as or different from each other. At least one of L¹¹, L¹², and L¹³ present in the structure does not represent a single bond; at least one of L¹⁴, L¹⁵, and L¹⁶ present therein does not represent a single bond; and at least one of L¹⁷, L¹⁸, and L¹⁹ present therein does not represent a single bond. L¹², L¹⁵, and L¹⁸ are each independently preferably —CH₂CH₂—, —(CH₂)—, —CH₂O—, or —CF₂O—; and more preferably —CH₂CH₂— or —CH₂O—. L¹¹, L¹³, L¹⁴, L¹⁶, L¹⁷, and L¹⁹ present in the structure are each independently preferably a single bond, —CH₂CH₂—, —OCH₂—, —CH₂O—, —OCF₂—, or —CF₂O—; and more preferably a single bond.

X¹¹ and X¹² each independently represent a trifluoromethyl group, a trifluoromethoxy group, or a fluorine atom; and preferably a fluorine atom. X¹³, X¹⁴, and X¹⁵ each independently represent a hydrogen atom, a trifluoromethyl group, a trifluoromethoxy group, or a fluorine atom; any one of X¹³, X¹⁴, and X¹⁵ represents a fluorine atom, and it is preferred that each of them represent a fluorine atom. X¹⁶, X¹⁷, and X¹⁸ each independently represent a hydrogen atom, a trifluoromethyl group, a trifluoromethoxy group, or a fluorine atom; any one of X¹⁶, X¹⁷, and X¹⁸ represents a fluorine atom; each of X¹⁶ and X¹⁷ does not represent a fluorine atom at the same time; each of X¹⁶ and X¹⁸ does not represent a fluorine atom at the same time; X¹⁶ preferably represents a hydrogen atom; and X¹⁷ and X¹⁸ each preferably represents a fluorine atom.

G represents a methylene group or —O—, and preferably —O—.

Among the compounds represented by General Formulae (Ia), (Ib), and (Ic) as representative examples of the second component, the compound represented by General Formula (Ia) is especially preferred.

The compound represented by General Formula (Ia) is preferably a compound selected from the following compounds; more preferably a compound selected from compounds represented by General Formulae (Ia-1), (Ia-2), (Ia-4), and (Ia-5); and especially preferably a compound selected from the compounds represented by General Formulae (Ia-2) and (Ia-5).

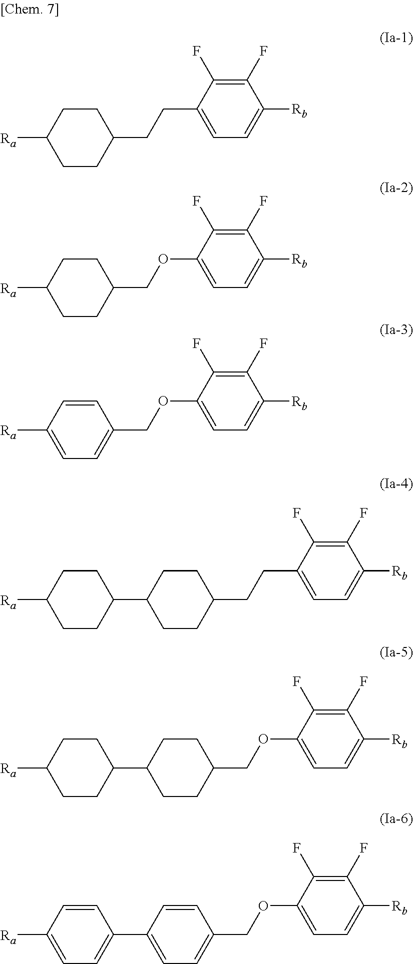

(in each of the formulae, Rₐ and R_{b} each independently represent an alkyl group having 1 to 7 carbon atoms, an alkoxy group having 1 to 7 carbon atoms, an alkenyl group having 2 to 6 carbon atoms, or an alkenyloxy group having 2 to 6 carbon atoms. In each of these alkyl, alkenyl, alkoxy, and alkenyloxy groups, at least one methylene group is optionally substituted with an oxygen atom provided that oxygen atoms are not bonded to each other in sequence, and at least one hydrogen atom is optionally substituted with a fluorine atom. Rₐ is preferably an alkyl group having 1 to 5 carbon atoms, an alkoxy group having 1 to 5 carbon atoms, or an alkenyl group having 2 to 5 carbon atoms; and R_{b} is preferably an alkyl group having 1 to 5 carbon atoms or an alkoxy group having 1 to 5 carbon atoms) In the case where Ra and/or Rb each represent an alkenyl group, such an alkenyl group is preferably any of the following substituents represented by Formulae (Alkenyl-1) to (Alkenyl-4).

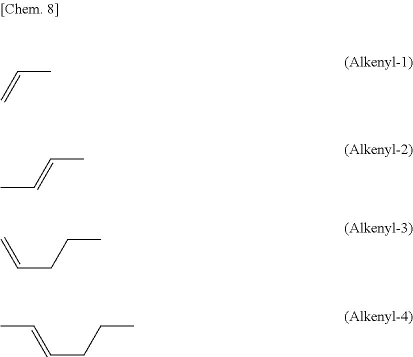

(in each of the formulae, the right end is bonded to the ring structure)

The alkenyl group is also preferably any of the substituents represented by Formulae (Alkenyl-2) and/or (Alkenyl-4).

The amount of the compound represented by General Formula (Ia) in the liquid crystal composition of the present invention is preferably in the range of 10 to 50 mass %, more preferably 15 to 40 mass %, and further preferably 20 to 35 mass %.

The second component to be used is also preferably any of compounds represented by General Formula (Id).

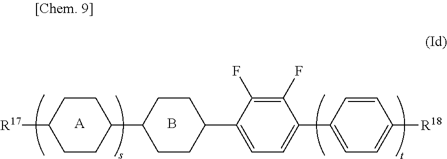

In the formula, R¹⁷ and R¹⁸ each independently represent an alkyl group having 1 to 10 carbon atoms or an alkenyl group having 2 to 10 carbon atoms; in each of the alkyl and alkenyl groups, one methylene group or at least two methylene groups not adjoining each other are each optionally substituted with —O— or —S—, and at least one hydrogen atom is optionally substituted with a fluorine atom or a chlorine atom. R¹⁷ is preferably an alkyl group having 1 to 5 carbon atoms, an alkoxy group having 1 to 5 carbon atoms, or an alkenyl group having 2 to 5 carbon atoms; and more preferably an alkyl group having 1 to 5 carbon atoms. R¹⁸ is preferably an alkyl group having 1 to 5 carbon atoms, an alkoxy group having 1 to 5 carbon atoms, or an alkenyl group having 2 to 5 carbon atoms; more preferably an alkyl group having 1 to 4 carbon atoms or an alkoxy group having 1 to 4 carbon atoms. s and t are each independently from 0 to 2, and s+t is equal to 2 or lower; in the case where s is 0, t is preferably 0 or 1; and in the case where s is 1, t is preferably 0. The rings A and B each independently represent a trans-1,4-cyclohexylene group, a 1,4-phenylene group, a 1,4-cyclohexenylene group, a 1,4-bicyclo(2.2.2)octylene group, a naphthalene-2,6-diyl group, a 1,2,3,4-tetrahydronaphthalene-2,6-diyl group, or a decahydronaphthalene-2,6-diyl group. The ring A is preferably a trans-1,4-cyclohexylene group or a 1,4-phenylene group, and more preferably a trans-1,4-cyclohexylene group. The ring B is preferably a trans-1,4-cyclohexylene group or a 1,4-phenylene group.

Specific examples of the compound represented by General Formula (Id) include compounds represented by General Formulae ((Id-1) to (Id-8).

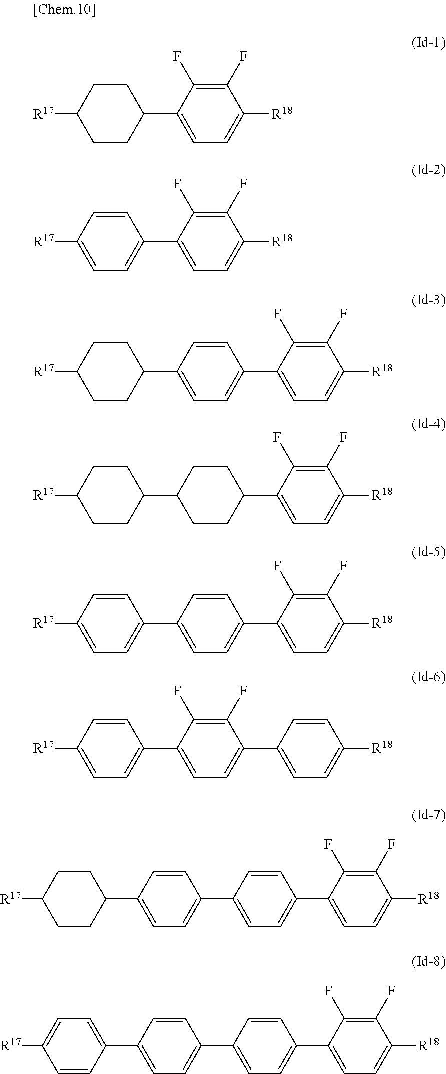

The amount of the compound represented by General Formula (Id) in the liquid crystal composition of the present invention is preferably in the range of 10 to 40 mass %, more preferably 15 to 35 mass %, and further preferably 15 to 30 mass %.

In the case where R¹⁷ and/or R¹⁸ each represent an alkenyl group, such an alkenyl group is preferably any of the following substituents represented by Formulae (Alkenyl-1) to (Alkenyl-4).

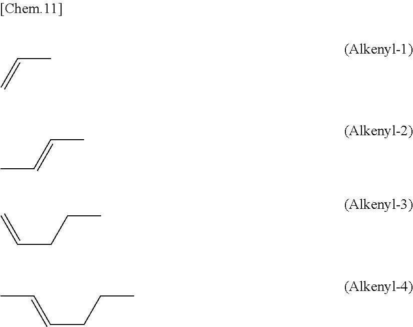

(in each of the formulae, the right end is bonded to the ring structure)

The alkenyl group is also preferably any of the substituents represented by Formulae (Alkenyl-2) and/or (Alkenyl-4).

The compound represented by General Formula (Id) is preferably any of compounds represented by General Formulae (Np-1) and (Np-2).

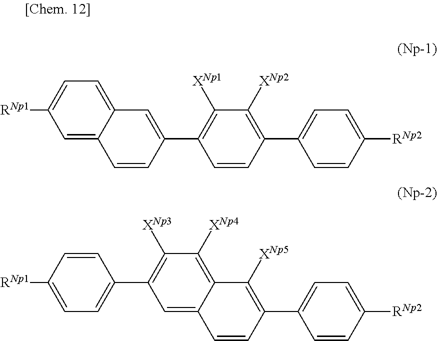

(in the formulae, R^{Np1} and R^{Np2} each independently represent an alkyl group having 1 to 5 carbon atoms or an alkenyl group having 2 to 5 carbon atoms; in each of the alkyl and alkenyl groups, one —CH₂— moiety or at least two —CH₂— moieties not adjoining each other are each independently optionally substituted with —O— or —S—, and one or more hydrogen atoms are each independently optionally substituted with a fluorine atom; and X^{Np1}, X^{Np2}, X^{Np3}, X^{Np4}, and X^{Np5} each independently represent a hydrogen atom or a fluorine atom) Using the compounds represented by General Formulae (Np-1) and (Np-2) in a polymerizable-compound-containing liquid crystal composition used for producing PSA or PSVA liquid crystal display devices gives effects in which the polymerization rate of the polymerizable compound is sufficiently high and in which the residue of the polymerizable compound after the polymerization is eliminated or sufficiently reduced. Hence, for example, these compounds can be also employed as an adjuster that adjusts the polymerization rate of the polymerizable compound to be suitable for a lamp used for UV exposure in the polymerization.

The second component of the liquid crystal composition of the present invention is a compound having a negative dielectric anisotropy (Δ∈) with an absolute value of greater than three and preferably mainly includes the compounds represented by General Formulae (Ia) and (Id). The total amount of the compounds represented by General Formulae (Ia) and (Id) in the second component is preferably in the range of 90 to 100 mass %, more preferably 92 to 100 mass %, and further preferably 95 to 100 mass %.

The liquid crystal composition of the present invention contains a polymerizable compound as a third component.

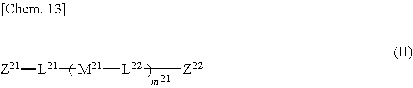

Specific examples of the third compound include compounds represented by General Formula (II).

In the formula, Z²¹ and Z²² each independently represent the following structure.

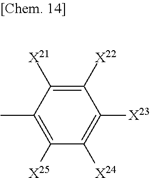

X²¹ to X²⁵ each represent a hydrogen atom, a fluorine atom, or the following structure.

—S²¹—R²¹ [Chem. 15]

At least one of X²¹ to X²⁵ in each of Z² and Z²² is the following structure.

—S²¹—R²¹ [Chem. 16]

X²³ in each of Z²¹ and Z²² is

—S²¹—R²¹ [Chem. 17]

preferably this structure.

S²¹ represents an alkyl group having 1 to 12 carbon atoms or a single bond, and a methylene group of the alkyl group is optionally substituted with an oxygen atom, —COO—, —OCO—, or —OCOO— provided that oxygen atoms are not directly bonded to each other.

R²¹ represents any of the following structures represented by Formulae (R-1) to (R-15).

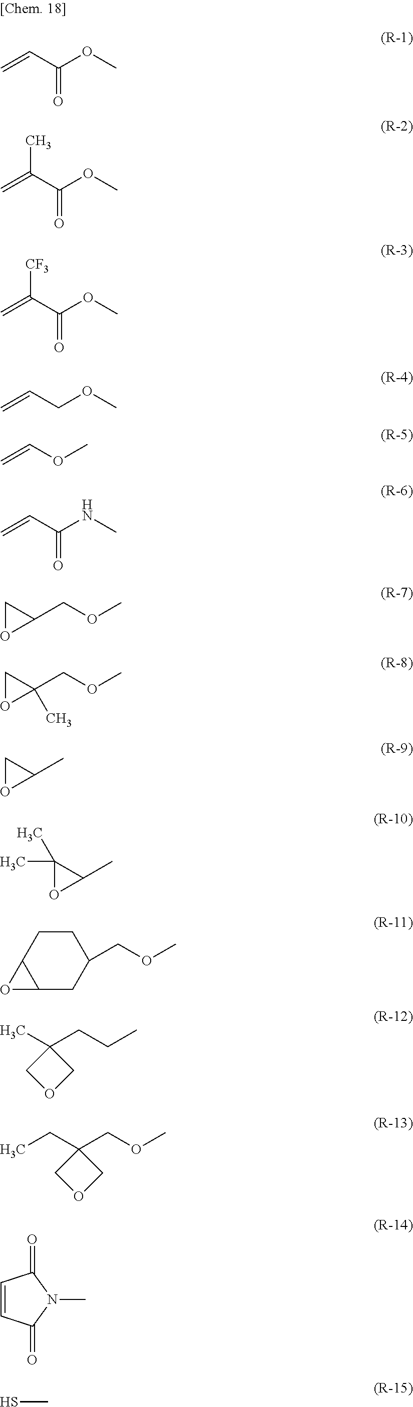

R²¹ preferably represents the structure represented by Formula (R-1) or (R-2).

L²¹ and L²² each independently represent a single bond, —O—, —CH₂—, —OCH₂—, —CH₂O—, —CO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O—, —OCF₂—, —CF₂CH₂—, —CH₂CF₂—, —CF₂CF₂—, or —C≡C—; in the case where L²² is multiple, the multiple L²²'s may be the same as or different from each other and preferably a single bond, —OCH₂—, —CHOO—, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, —C₂H₄OCO—, —C₂H₄COO—, —CF₂O—, —OCF₂—, or —C≡C—; and more preferably a single bond, —C₂H₄—, —COO—, —OCO—, —CH═CH—COO—, —COO—CH═CH—, —OCO—CH═CH—, —CH═CH—OCO—, —COOC₂H₄—, —OCOC₂H₄—, or —C₂H₄COO—.

M²¹ independently represents a 1,4-phenylene group, a 1,4-cyclohexylene group, or a naphthalene-2,6-diyl group and is independently optionally unsubstituted or subjected to substitution of a hydrogen atom thereof with a fluorine atom, a chlorine atom, an alkyl group having 1 to 8 carbon atoms, a halogenated alkyl group having 1 to 8 carbon atoms, a halogenated alkoxy group having 1 to 8 carbon atoms, an alkoxy group having 1 to 8 carbon atoms, a nitro group, or the following structure.

—S²¹—R²¹ [Chem. 19]

In the case where M²¹ is multiple, the multiple M²¹'s may be the same as or different from each other; M²¹ is preferably a 1,4-phenylene group that is unsubstituted or subjected to substitution of a hydrogen atom thereof with a fluorine atom, an alkyl group having 1 to 8 carbon atoms, or an alkoxy group having 1 to 8 carbon atoms. In this case, when M²¹ is multiple, the multiple M²¹'s may be the same as or different from each other.

m²¹ represents 0, 1, or 2 and preferably 0 or 1.

In particular, specific examples of the compound represented by General Formula (II), which is a polymerizable compound, include compounds represented by General Formula (II-1).

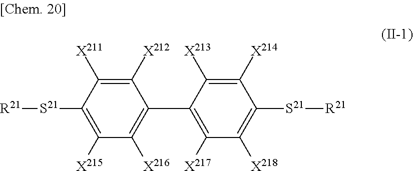

(in the formula, R²¹ and S²¹ have the same meanings as R²¹ and S²¹ in General Formula (II), respectively; and X²¹¹ to X²¹ each represent a hydrogen atom, a fluorine atom, or the following structure)

—S²¹—R²¹ [Chem. 21]

In the compound represented by General Formula (II), the above biphenyl skeleton preferably has any of structures represented by Formulae (IV-11) to (IV-14), and preferably Formula (IV-11).

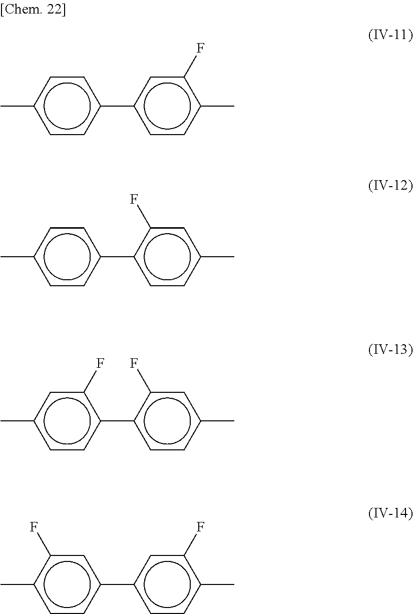

A polymerizable compound having any of the skeletons represented by Formulae (IV-11) to (IV-14) has an optimum alignment-regulating force after polymerization, which gives a good alignment state.

Other examples of the compound represented by General Formula (II) include compounds represented by General Formula (II-2).

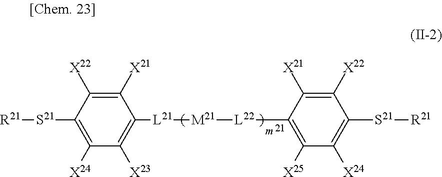

(in the formula, R²¹, S²¹, L²¹, L²², M²¹, and m²¹ have the same meanings as R²¹, S²¹, L²¹, L²², M²¹, and m²¹ in General Formula (II), respectively; and X²¹ to X²⁵ each represent a hydrogen atom, a fluorine atom, or the following structure)

—S²¹—R²¹ [Chem. 24]

Specifically, the compound represented by General Formula (II), which is a polymerizable compound, is preferably any of compounds represented by Structural Formulae (M1-1) to (M1-13), (M2-1) to (M2-8), (M3-1) to (M3-6), and (M4-1) to (M4-7).

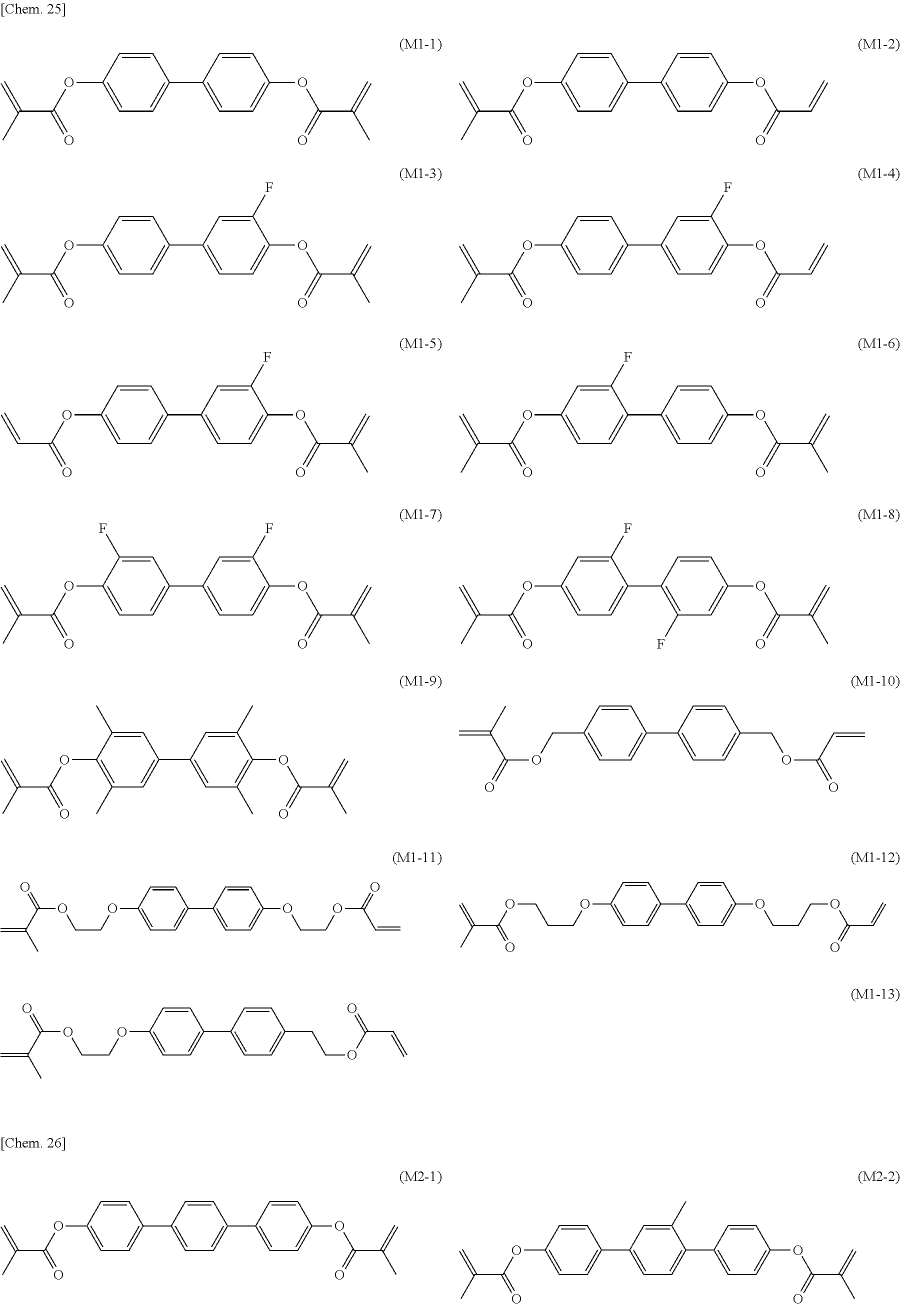

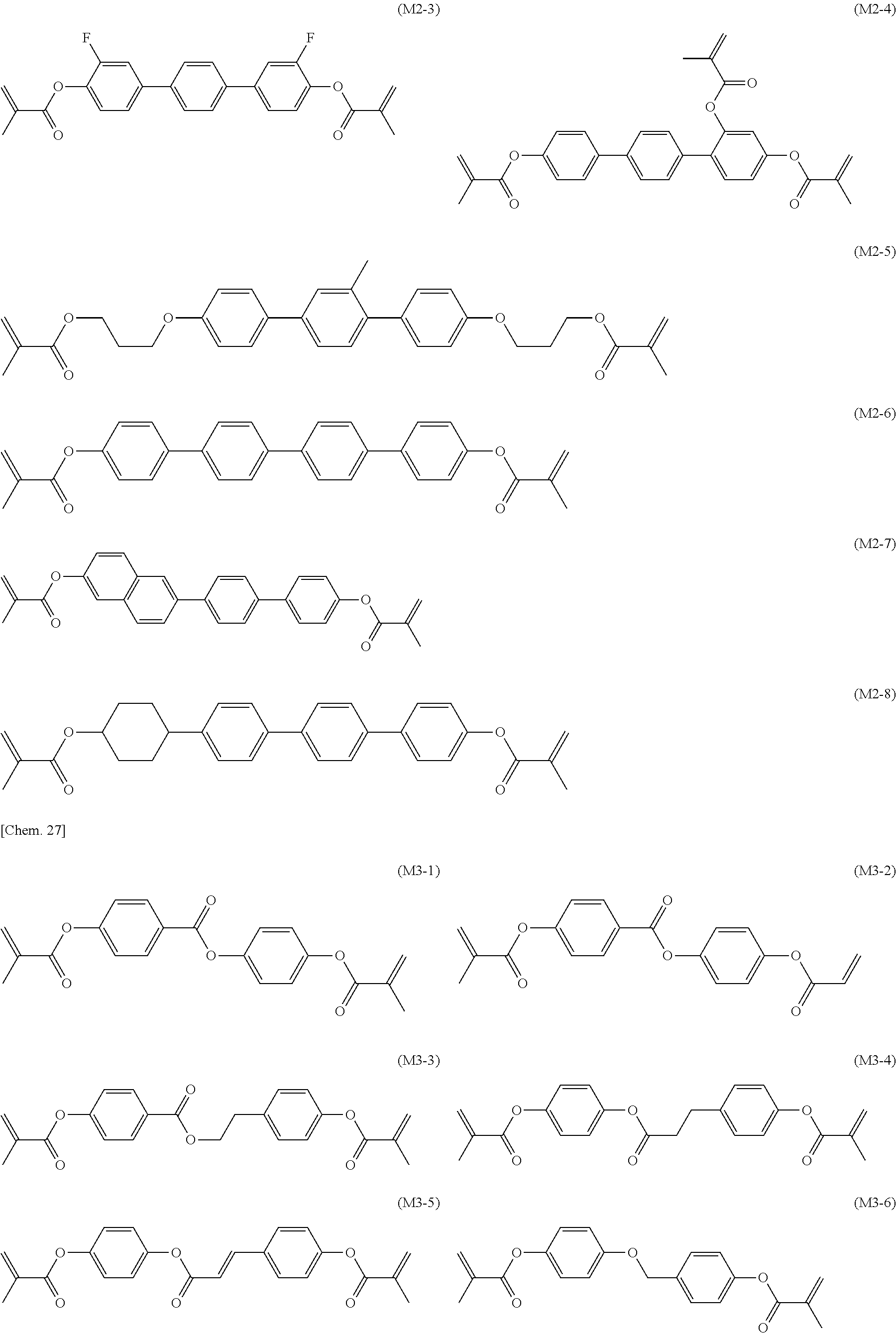

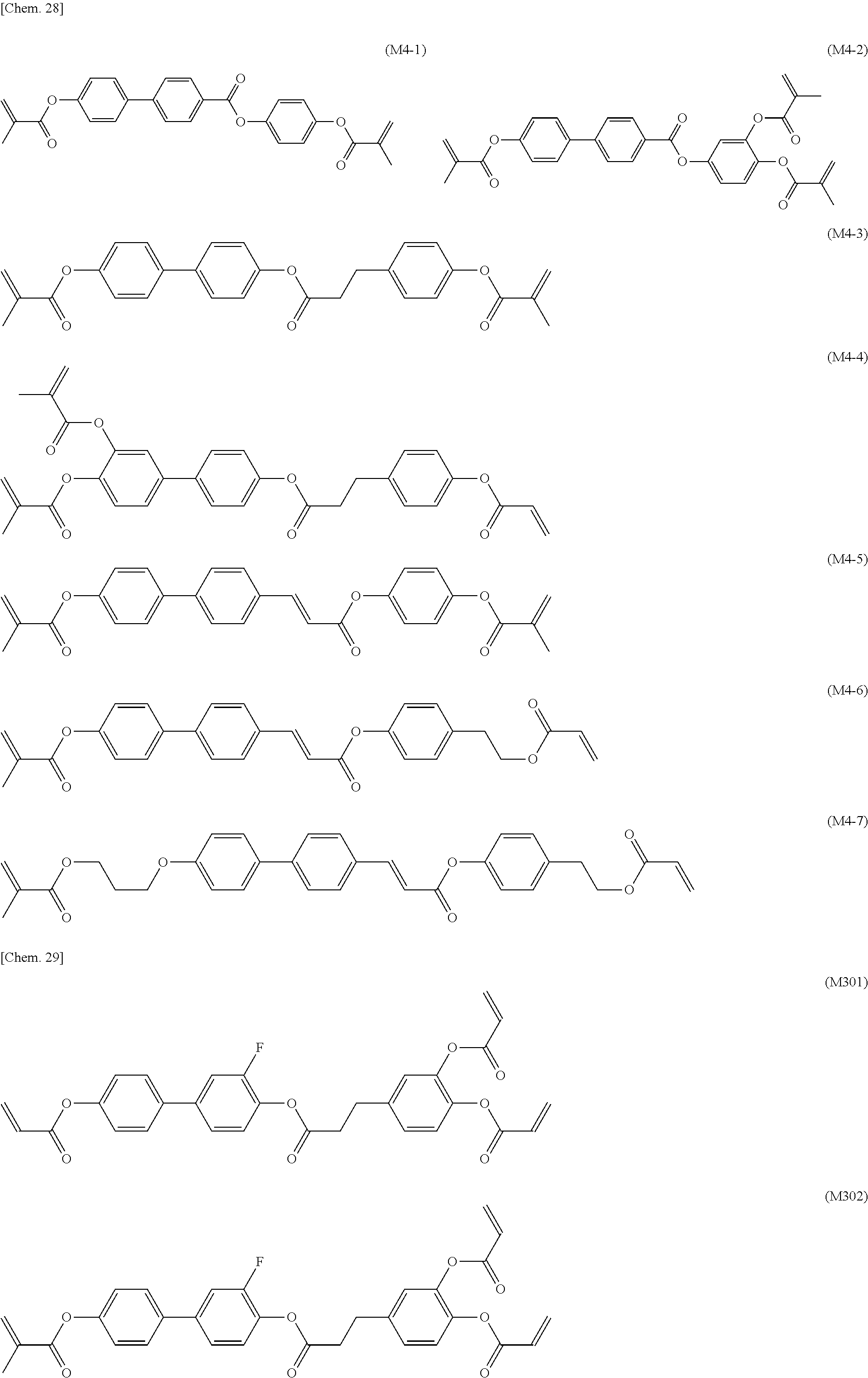

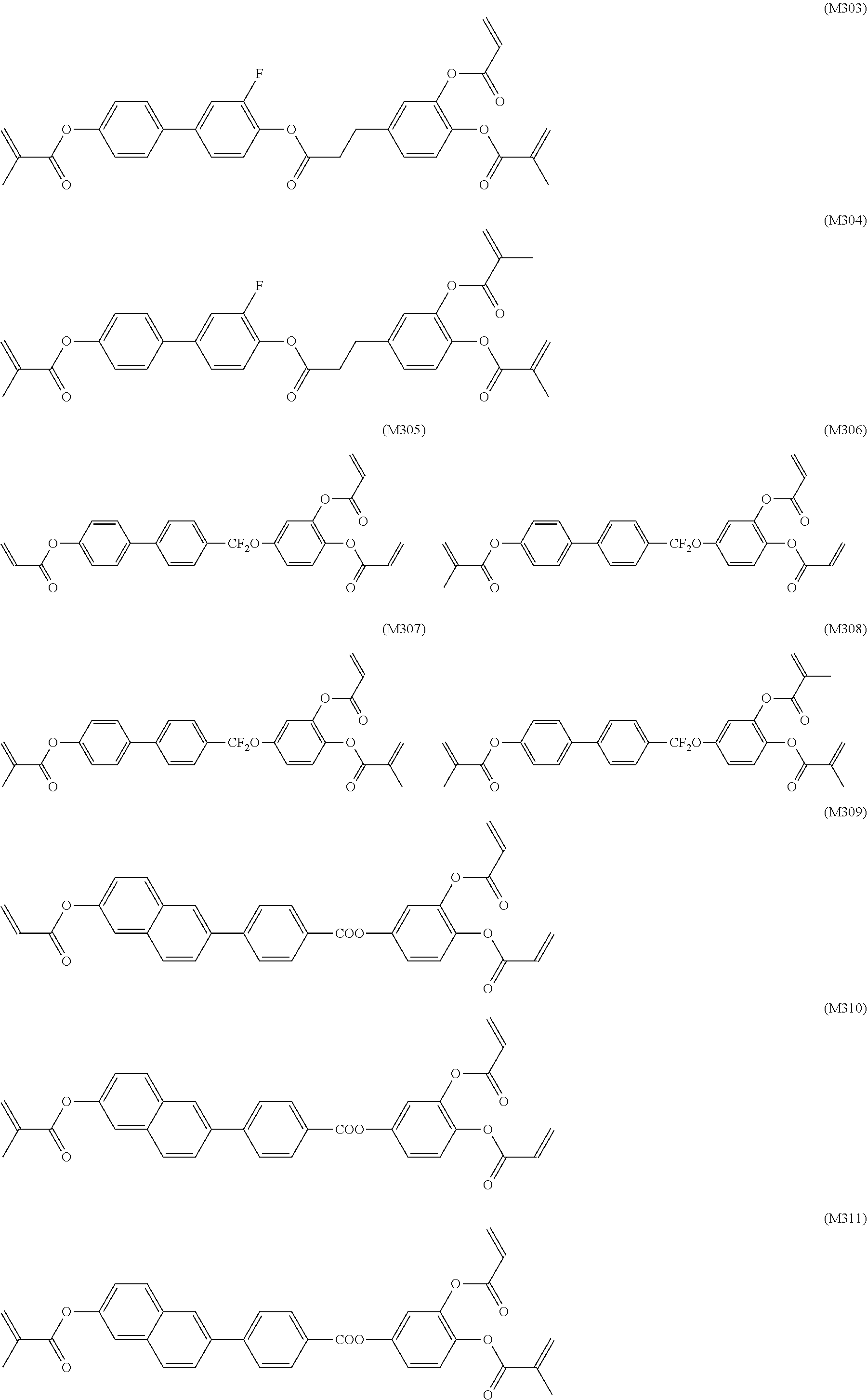

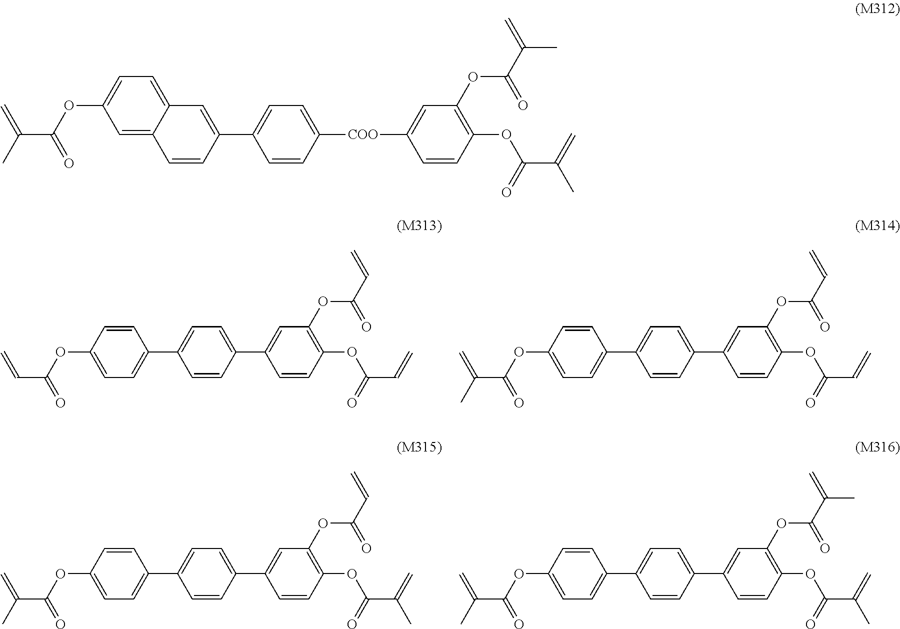

The compound is more preferably any of compounds represented by Structural Formulae (M1-1) to (M1-8), (M1-10) to (M1-13), (M2-2) to (M2-5), (M3-1), (M3-4), (M3-5), (M4-1), (M4-2), (M4-4), (M4-6), (M4-7), (M301) to (M304), and (M309) to (M316); and

especially preferably Structural Formulae (M1-1), (M1-3), (M1-6) to (M1-8), (M1-11), (M1-12), (M2-2), (M2-4), (M3-1), (M3-5), (M4-2), (M4-6), (M4-7), (M301) to (M304), and (M309) to (M312).

At least one of compounds represented by General Formula (II) is used as the third component; it is preferred that one to five of the compounds be used, and it is more preferred that one to three thereof be used. Insufficiency in the amount of the compound represented by General Formula (II) results in weak alignment-regulating force that affects the liquid crystal composition. Excess in the amount of the compound represented by General Formula (II) enhances necessary energy for polymerization and therefore increases the amount of the polymerizable compound that remains without being polymerized, which causes defective display. Thus, the amount is preferably in the range of 0.01 to 2.00 mass %, more preferably 0.05 to 1.00 mass %, and especially preferably 0.10 to 0.50 mass %.

The liquid crystal composition of the present invention contains a fourth component that is a compound having a dielectric anisotropy (Δ∈) of substantially zero, specifically, a compound having Δ∈ that is greater than −3 and smaller than 3. In particular, any of compounds represented by General Formula (IV) is preferably used.

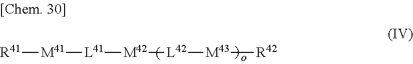

(the compounds represented by General Formula (IV) exclude the compound represented by Formula (I))

In the formula, R⁴¹ and R⁴² each independently represent an alkyl group having 1 to 10 carbon atoms or an alkenyl group having 2 to 10 carbon atoms; in each of the alkyl and alkenyl groups, one methylene group or at least two methylene groups not adjoining each other are each optionally substituted with —O— or —S—, and at least one hydrogen atom is optionally substituted with a fluorine atom or a chlorine atom. R⁴¹ and R⁴² each independently preferably represent an alkyl group having 1 to 5 carbon atoms, an alkoxy group having 1 to 5 carbon atoms, or an alkenyl group having 2 to 5 carbon atoms.

o represents 0, 1, or 2 and preferably 0 or 1.

M⁴¹, M⁴², and M⁴³ each independently represent a group selected from the group consisting of

(d) a trans-1,4-cyclohexylene group (of which one methylene group or at least two methylene groups not adjoining each other are optionally substituted with —O— or —S—);
(e) a 1,4-phenylene group (of which one —CH═ moiety or at least two —CH═ moieties not adjoining each other are optionally substituted with a nitrogen atom), a 3-fluoro-1,4-phenylene group, or a 3,5-difluoro-1,4-phenylene group; and
(f) a 1,4-cyclohexenylene group, a 1,4-bicyclo(2.2.2)octylene group, a piperidine-2,5-diyl group, a naphthalene-2,6-diyl group, a decahydronaphthalene-2,6-diyl group, and a 1,2,3,4-tetrahydronaphthalene-2,6-diyl group. In the case where M⁴³ is multiple, the multiple M⁴³'s may be the same as or different from each other; M⁴¹ is preferably a trans-1,4-cyclohexylene group, a 1,4-phenylene group, or a 3-fluoro-1,4-phenylene group; and more preferably a trans-1,4-cyclohexylene group or a 1,4-phenylene group.

L⁴¹ and L⁴² each independently represent a single bond, —CH₂CH₂—, —(CH₂)₄—, —OCH₂—, —CH₂O—, —OCF₂—, —CF₂O—, —CH═CH—, —CH═N—N═CH—, or —C≡C—; in the case where L⁴² is multiple, the multiple L⁴'s may be the same as or different from each other. L⁴² is preferably a single bond, —CH₂CH₂—, —(CH₂)₄—, —OCH₂—, —CH₂O—, —OCF₂—, —CF₂O—, or —CH═CH—; more preferably a single bond or —CH₂CH₂—; and especially preferably a single bond.

The amount of the compound represented by General Formula (IV) in the liquid crystal composition of the present invention is preferably in the range of 10 to 70 mass %, more preferably 20 to 60 mass %, and further preferably 25 to 50 mass %.

Preferred examples of the compound represented by General Formula (IV) include compounds represented by General Formulae (IV-1) to (IV-6).

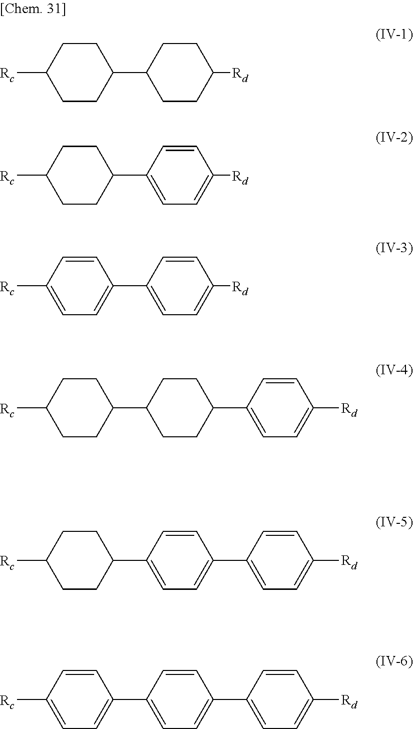

(in each of the formulae, R: and R_{d} each independently represent an alkyl group having 1 to 7 carbon atoms, an alkoxy group having 1 to 7 carbon atoms, an alkenyl group having 2 to 6 carbon atoms, or an alkenyloxy group having 2 to 6 carbon atoms; in each of these alkyl, alkenyl, alkoxy, and alkenyloxy groups, at least one methylene group is optionally substituted with an oxygen atom provided that oxygen atoms are not bonded to each other in sequence, and at least one hydrogen atom is optionally substituted with a fluorine atom; and compounds represented by Formula (IV-1) exclude the compound represented by Formula (I))

The fourth component of the liquid crystal composition of the present invention is a compound having a dielectric anisotropy (Δ∈) of substantially zero and preferably mainly includes the compounds represented by General Formulae (IV-1) to (IV-6) in order to give good viscosity, rotational viscosity, specific resistance, and voltage holding ratio.

The total amount of the compounds represented by General Formulae (IV-1) to (IV-6) in the fourth component is preferably in the range of 90 to 100 mass %, more preferably 92 to 100 mass %, and further preferably 95 to 100 mass %.

In the case where R_{c} and/or R_{d} each represent an alkenyl group, such an alkenyl group is preferably any of the following substituents represented by Formulae (Alkenyl-1) to (Alkenyl-4).

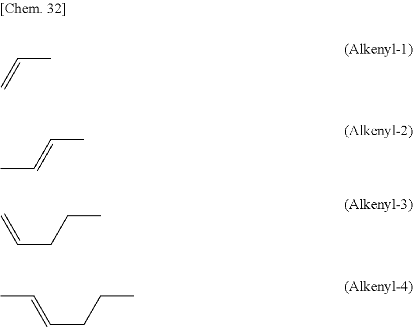

(in each of the formulae, the right end is bonded to the ring structure)

The alkenyl group is also preferably any of the substituents represented by Formulae (Alkenyl-2) and/or (Alkenyl-4).

The fourth component to be used also can be at least one of compounds represented by General Formulae (VIII-a), (VIII-c), and (VIII-d).

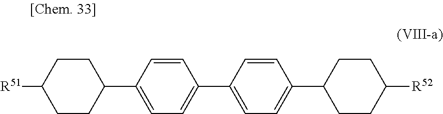

(in the formula, R⁵¹ and R⁵² each independently represent an alkyl group having 1 to 5 carbon atoms, an alkenyl group having 2 to 5 carbon atoms, or an alkoxy group having 1 to 4 carbon atoms)

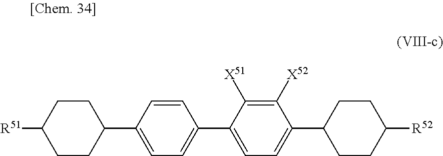

(in the formula, R⁵¹ and R⁵² each independently represent an alkyl group having 1 to 5 carbon atoms, an alkenyl group having 2 to 5 carbon atoms, or an alkoxy group having 1 to 4 carbon atoms; X⁵¹ and X⁵² each independently represent a fluorine atom or a hydrogen atom; at least one of X⁵¹ and X⁵² is a fluorine atom, and each of them does not represent a fluorine atom at the same time)

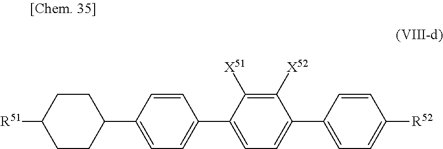

(in the formula, R⁵¹ and R⁵² each independently represent an alkyl group having 1 to 5 carbon atoms, an alkenyl group having 2 to 5 carbon atoms, or an alkoxy group having 1 to 4 carbon atoms; X⁵¹ and X⁵² each independently represent a fluorine atom or a hydrogen atom; at least one of X⁵¹ and X⁵² is a fluorine atom, and each of them does not represent a fluorine atom at the same time)

The dielectric anisotropy (Δ∈) of the liquid crystal composition of the present invention at 25° C. is from −2.0 to −8.0, preferably −2.0 to −6.0, more preferably −2.0 to −5.0, and especially preferably −2.5 to −4.0.

The refractive index anisotropy (Δn) of the liquid crystal composition of the present invention at 20° C. is from 0.08 to 0.14, preferably 0.09 to 0.13, and especially preferably 0.09 to 0.12. More specifically, the refractive index anisotropy is preferably from 0.10 to 0.13 for a thin cell gap or preferably from 0.08 to 0.10 for a thick cell gap.

The viscosity (η) of the liquid crystal composition of the present invention at 20° C. is from 10 to 30 mPa·s, preferably 10 to 25 mPa·s, and especially preferably 10 to 22 mPa·s.

The rotational viscosity (γ₁) of the liquid crystal composition of the present invention at 20° C. is from 60 to 130 mPa·s, preferably 60 to 110 mPa·s, and especially preferably 60 to 100 mPa·s.

The ratio of rotational viscosity (γ₁) to an elastic constant (K₃₃) at 20° C. (γ₁/K₃₃) in the liquid crystal composition of the present invention is in the range of 3.5 to 9.0 mPa·s·pN⁻¹, preferably 3.5 to 8.0 mPa·s·pN⁻¹, and especially preferably 3.5 to 7.0 mPa·s·pN⁻¹.

The nematic phase-isotropic liquid phase transition temperature (Tₙᵢ) of the liquid crystal composition of the present invention is from 60° C. to 120° C., more preferably 70° C. to 100° C., and especially preferably 70° C. to 85° C.

Since the liquid crystal composition of the present invention contains a polymerizable compound, polymerization progresses without a polymerization initiator; however, a polymerization initiator may be used to promote the polymerization. Examples of the polymerization initiator include benzoin ethers, benzophenones, acetophenones, benzyl ketals, and acyl phosphine oxides. In order to enhance storage stability, a stabilizer may be added. Examples of usable stabilizers include hydroquinones, hydroquinone monoalkylethers, tertiary butylcatechol, pyrogallols, thiophenols, nitro compounds, β-naphthylamines, β-naphthols, and nitroso compounds.

The liquid crystal composition of the present invention may further contain a compound represented by General Formula (Q).

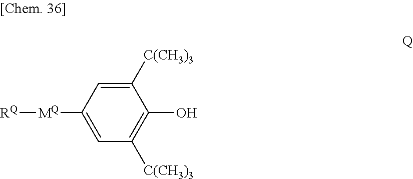

In the formula, R^{Q} represents a linear or branched alkyl group having 1 to 22 carbon atoms; one CH₂ group or at least two CH₂ groups not adjoining each other in the alkyl group are optionally substituted with —O—, —CH═CH—, —CO—, —OCO—, —COO—, —C≡C—, —CF₂O—, or —OCF₂—.

M^{Q} represents a trans-1,4-cyclohexylene group, a 1,4-phenylene group, or a single bond.

In particular, the compound represented by General Formula (Q) is preferably any of compounds represented by General Formulae (Q-a) to (Q-e).

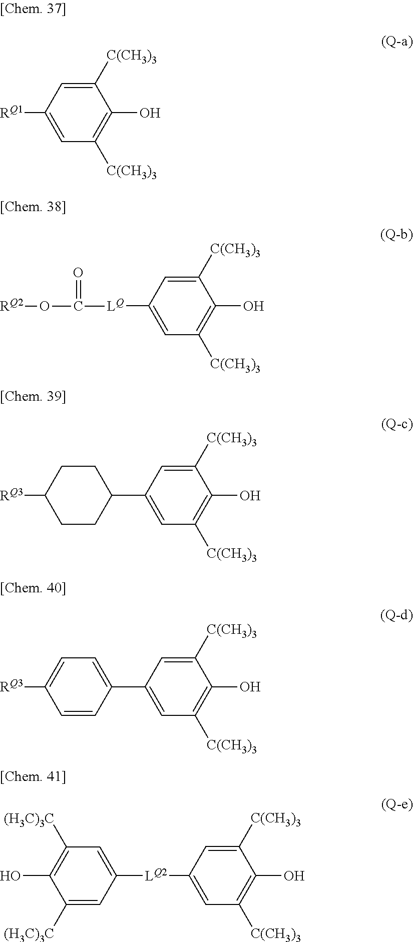

In the formula, R^{1′} is preferably a linear or branched alkyl group having 1 to 10 carbon atoms.

R^{Q2} is preferably a linear or branched alkyl group having 1 to 20 carbon atoms.

R^{Q3} is preferably a linear or branched alkyl or alkoxy group having 1 to 8 carbon atoms.

L^{Q} is preferably a linear or branched alkylene group having 1 to 8 carbon atoms.

L^{Q2} is preferably a linear or branched alkylene group having 2 to 12 carbon atoms.

Among the compounds represented by General Formulae (Q-a) to (Q-e), the compounds represented by General Formulae (Q-c), (Q-d), and (Q-e) are more preferred.

The liquid crystal composition of the present invention contains at least one of compounds represented by General Formula (Q); it is preferred that one to five of the compounds be used, it is more preferred that one to three of the compounds be used, and it is especially preferred that one of the compounds be used. The amount of the compound is preferably in the range of 0.001 mass % to 1 mass %, more preferably 0.001 mass % to 0.1 mass %, and especially preferably 0.001 mass % to 0.05 mass %.

The polymerizable-compound-containing liquid crystal composition of the present invention is useful for liquid crystal display devices; in particular, it is useful for an active-matrix liquid crystal display device and can be applied to PSA, PSVA, VA, IPS, and ECB liquid crystal display devices.

In the liquid crystal composition of the present invention, the polymerizable compound is polymerized by being irradiated with ultraviolet, so that liquid crystal molecules can be aligned; thus, such a liquid crystal composition is used in liquid crystal display devices in which the birefringence of the liquid crystal composition is utilized for control of the amount of light that is to be transmitted. Such a liquid crystal composition is useful for liquid crystal display devices, such as an AM-LCD (active-matrix liquid crystal display device), a TN (nematic liquid crystal display device), an STN-LCD (super twisted nematic liquid crystal display device), an OCB-LCD, and an IPS-LCD (in-plane switching liquid crystal display device), particularly useful for an AM-LCD, and can be used in transmissive or reflective liquid crystal display devices.

Two substrates used in a liquid crystal cell included in a liquid crystal display device can be made of a transparent material having flexibility, such as glass or a plastic material, and one of these substrates may be made of a non-transparent material such as silicon. In order to form a transparent electrode layer on a transparent substrate such as a glass plate, for example, indium tin oxide (ITO) is sputtered on the transparent substrate.

A color filter can be produced by, for instance, a pigment dispersion technique, a printing technique, an electrodeposition technique, or a staining technique. In production of the color filter by, for example, a pigment dispersion technique, a curable colored composition for a color filter is applied onto the transparent substrate, subjected to patterning, and then cured by being heated or irradiated with light. This process is carried out for each of three colors of red, green, and blue, thereby being able to produce the pixels of the color filter. Active elements such as a TFT, a thin-film diode, a metal insulator, and a metal specific resistance element may be provided on the resulting substrate to form pixel electrodes.

The substrates are arranged so as to face each other with the transparent electrode layer interposed therebetween. In the arrangement of the substrates, a spacer may be present between the substrates to adjust the distance therebetween. In this case, the distance between the substrates is adjusted so that the thickness of a light modulating layer to be formed is preferably in the range of 1 to 100 μm, and more preferably 1.5 to 10 μm. In the case where a polarizing plate is used, the product of the refractive index anisotropy Δn of liquid crystal and a cell thickness d is preferably adjusted for maximization of contrast. In the case where two polarizing plates are used, the polarization axis of each polarizing plate may be adjusted to give a good viewing angle or contrast. Furthermore, a retardation film may be also used to increase a viewing angle. The spacer can be made of, for instance, glass particles, plastic particles, alumina particles, or photoresist materials. A sealing material such as a thermosetting epoxy composition is subsequently applied to the substrates by screen printing in a state in which a liquid crystal inlet has been formed, the substrates are attached to each other, and then the sealing material is heated to be thermally cured.

The polymerizable-compound-containing liquid crystal composition can be put into the space between the two substrates by, for example, a vacuum injection technique or ODF technique which is generally employed.

Since a proper polymerization rate is desired to enable liquid crystal molecules to be aligned in a good manner, the polymerizable compound is preferably polymerized by being irradiated with one of active energy rays, such as an ultraviolet ray and an electron beam, or by being irradiated with such active energy rays used in combination or in sequence. In the use of an ultraviolet ray, a polarized light source or a non-polarized light source may be used. In the case where the polymerizable-compound-containing liquid crystal composition is polymerized in a state in which the composition has been disposed between the two substrates, at least the substrate on the side from which active energy rays are emitted needs to have transparency suitable for the active energy rays. Another technique may be used, in which only the intended part is polymerized by being irradiated with light with a mask, the alignment state of the non-polymerized part is subsequently changed by adjustment of conditions such as an electric field, a magnetic field, or temperature, and then polymerization is further carried out through irradiation with active energy rays. In particular, it is preferred that exposure to ultraviolet radiation be carried out while an alternating current electric field is applied to the liquid crystal composition of the present invention. The alternating current electric field to be applied preferably has a frequency ranging from 10 Hz to 10 kHz, and more preferably 60 Hz to 10 kHz; and the voltage is determined on the basis of a predetermined pretilt angle in a liquid crystal display device. In other words, the pretilt angle in a liquid crystal display device can be controlled by adjustment of voltage that is to be applied. In MVA liquid crystal display devices, a pretilt angle needs to be controlled to be from approximately 80 degrees to approximately 88 degrees in view of alignment stability and contrast, and use of the liquid crystal composition of the present invention enables a pretilt angle to be controlled to a predetermined level.

The temperature in the irradiation procedure is preferably within a temperature range in which the liquid crystal state of the liquid crystal composition of the present invention can be maintained. Polymerization is preferably carried out at a temperature close to room temperature, i.e., typically from 15 to 35° C. Preferred examples of a lamp that is usable for emitting an ultraviolet ray include a metal halide lamp, a high pressure mercury lamp, and an ultrahigh pressure mercury lamp. In addition, an ultraviolet ray to be emitted preferably has a wavelength that is in a wavelength region different from the wavelength region of light absorbed by the liquid crystal composition; it is preferred that an ultraviolet ray in a particular wavelength range be cut off as needed. The intensity of an ultraviolet ray to be emitted is preferably from 0.1 mW/cm² to 100 W/cm², and more preferably 2 mW/cm² to 50 W/cm². The energy of an ultraviolet ray to be emitted can be appropriately adjusted: preferably from 10 mJ/cm² to 500 J/cm², and more preferably 100 mJ/cm² to 200 J/cm². The intensity may be changed in the exposure to ultraviolet radiation. The time of the exposure to ultraviolet radiation is appropriately determined on the basis of the intensity of an ultraviolet ray to be emitted: preferably from 10 seconds to 3600 seconds, and more preferably 10 seconds to 600 seconds.

### EXAMPLES

Although the present invention will now be described further in detail with reference to Examples, the present invention is not limited thereto. In compositions which will be described in Examples and Comparative Examples, the term “%” refers to “mass %”.

In Examples, compounds are abbreviated as follows.

### (Side Chains)

-n —CₙH₂ₙ₊₁ linear alkyl group having n carbon atoms
n- CₙH₂ₙ₊₁— linear alkyl group having n carbon atoms
—On —OCₙH₂ₙ₊₁ linear alkoxyl group having n carbon atoms
nO— CₙH₂n+₁O— linear alkoxyl group having n carbon atoms

### —V —CH═CH₂

### V— CH₂═CH—

### —V1 —CH═CH—CH₃

### 1V— CH₃—CH═CH—

### -2V —CH₂—CH₂—CH═CH₃

### V2- CH₃═CH—CH₂—CH₂—

### -2V1 —CH₂—CH₂—CH═CH—CH₃

### 1V2- CH₃—CH═CH—CH₂—CH₂

### (Ring Structures)

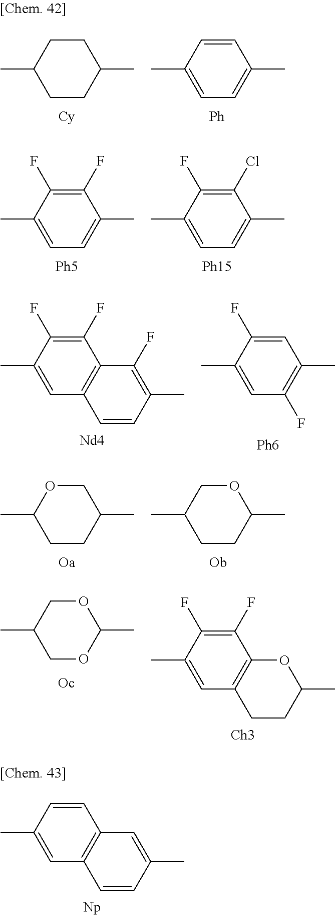

In Examples, the following properties were measured.

Tₙᵢ: Nematic phase-isotropic liquid phase transition temperature (° C.)

Δn: Refractive index anisotropy at 20° C.

Δ∈d: Dielectric anisotropy at 25° C.

η: Viscosity at 20° C. (mPa·s)

γ₁: Rotational viscosity at 20° C. (mPa·s)

K₃₃: Elastic constant K₃₃ at 20° C. (pN)

Tilt angle (initial): Tilt angle after injection into a test panel (°)

Tilt angle (after PSA): Tilt angle after exposure to UV at 50 J under application of a square wave of 5.0 V at a frequency of 1 kHz (°)

### Comparative Examples 1 and 2 and Examples 1 and 2

Polymerizable-compound-containing liquid crystal compositions LC-A (Comparative Example 1), LC-B (Comparative Example 2), LC-1 (Example 1), and LC-2 (Example 2) were prepared; and the physical properties thereof were measured. Table 1 shows the components and physical properties of the polymerizable-compound-containing liquid crystal compositions.

TABLE 1

| | | Comparative | Comparative | | |
|---|---|---|---|---|---|
| | | Example 1 | Example 2 | Example 1 | Example 2 |
| | | LC-A | LC-B | LC-1 | LC-2 |
| 3-Cy-Cy-2 | Formula (IV-1) | 18 | | 11 | 2 |
| 3-Cy-Cy-4 | Formula (IV-1) | 8 | | 8 | 8 |
| 3-Cy-Cy-V | Formula (I) | | 30 | 10 | 20 |
| 3-Cy-Ph—O1 | Formula (IV-2) | 4 | 4 | 4 | 4 |
| 3-Ph—Ph-1 | Formula (IV-3) | 11 | 8 | 9 | 9 |
| 3-Cy-Cy-Ph-1 | Formula (IV-4) | 5 | 5 | 5 | 4 |
| 3-Cy-1O—Ph5—O2 | Formula (Ia-2) | 11 | 11 | 11 | 11 |
| 2-Cy-Cy-1O—Ph5—O2 | Formula (Ia-5) | 6 | 6 | 6 | 6 |
| 3-Cy-Cy-1O—Ph5—O2 | Formula (Ia-5) | 11 | 10 | 10 | 10 |
| 3-Cy-Ph—1O—Ph5—O3 | Formula (Id-3) | 7 | 7 | 7 | 7 |
| 3-Cy-Ph—1O—Ph5—O4 | Formula (Id-3) | 8 | 8 | 8 | 8 |
| 4-Cy-Ph—1O—Ph5—O3 | Formula (Id-3) | 6 | 6 | 6 | 6 |
| 3-Ph—Ph5—Ph-2 | Formula (Id-6) | 5 | 5 | 5 | 5 |
| Polymerizable compound | Formula (M1-3) | 0.4 | 0.4 | 0.4 | 0.4 |
| | Total | 100.4 | 100.4 | 100.4 | 100.4 |
| Physical properties | T_{NI} [° C.] | 75.3 | 76.0 | 76.1 | 76.2 |
| | Δn [—] | 0.109 | 0.109 | 0.108 | 0.109 |
| | Δε [—] | −3.1 | −3.2 | −3.1 | −3.1 |
| | γ₁ [mPa · s] | 118 | 106 | 111 | 109 |
| | K₃₃ [pN] | 13.0 | 12.9 | 13.0 | 13.1 |
| | γ₁/K₃₃ [mPa · s · pN⁻¹] | 9.1 | 8.2 | 8.5 | 8.3 |
| Tilt angle [°] | Initial | 86.2 | 86.5 | 86.3 | 86.3 |
| | After PSA | 83.8 | 86.4 | 84.0 | 84.5 |
| | Induced tilt angle | 2.4 | 0.1 | 2.3 | 1.8 |

Each of these polymerizable-compound-containing liquid crystal compositions was injected by vacuum injection into an ITO-provided cell having a cell gap of 3.5 μm and including polyimide alignment films used for inducing homeotropic alignment and subjected to rubbing. This cell was irradiated with UV at a radiation intensity of 100 mW/cm² on the surface of the cell with a high pressure mercury lamp via a filter used for cutting off ultraviolet having a wavelength of not more than 320 nm under application of a square wave of 5.0 V at a frequency of 1 kHz, thereby producing a vertical-alignment liquid crystal display device (PSA cell) in which the polymerizable compound in the polymerizable-compound-containing liquid crystal composition had been polymerized. The pretilt angle was measured to determine the alignment-regulating force of the polymerizable compound on the liquid crystal compound.

The pretilt angle was measured at 25° C. with TBA105 manufactured by AUTRONIC-MELCHERS GmbH.

In each of the polymerizable-compound-containing liquid crystal compositions of LC-1 and LC-2 of the present invention, the irradiation with UV of 50 [J] gave an appropriate pretilt angle of approximately 2°, and γ₁/K₃₃ was sufficiently small. These PSA cells each had a high contrast and were able to quickly respond.
The LC-A as Comparative Example had a large γ₁/K₃₃ of 9.1; thus, the response speed thereof was at least 7% lower than those of the LC-1 and LC-2, which resulted in an unsatisfactory response speed. The LC-B had a small induced pretilt angle of 0.1°, and a sufficient pretilt angle was not given; thus, the response speed thereof was at least 10% lower than those of the LC-1 and LC-2, which resulted in an unsatisfactory response speed. In addition, the LC-B caused a reduction in contrast at driving.
These results showed that the polymerizable compounds in the polymerizable-compound-containing liquid crystal compositions LC-1 and LC-2 of the present invention each had a sufficiently higher response speed and enabled production of a PSA cell having an excellent quality as compared with the LC-A as Comparative Example 1 and the LC-B as Comparative Example 2.

Accordingly, the polymerizable-compound-containing liquid crystal compositions of the present invention enabled control of a pretilt angle that affects display qualities, such as quick response and high contrast, and allowed defective display, such as uneven display and screen burn-in, to be eliminated or significantly reduced.

### Examples 3 to 6

In order to research a variation based on a change in components, polymerizable-compound-containing liquid crystal compositions LC-3 (Example 3), LC-4 (Example 4), LC-5 (Example 5), and LC-6 (Example 6) were prepared; and the physical properties thereof were measured. Table 2 shows the components and physical properties of the polymerizable-compound-containing liquid crystal compositions.

TABLE 2

| | | Example 3 | Example 4 | Example 5 | Example 6 |
|---|---|---|---|---|---|
| | | LC-3 | LC-4 | LC-5 | LC-6 |
| 3-Cy-Cy-2 | Formula (IV-1) | 4 | 11 | 6 | 10 |
| 3-Cy-Cy-4 | Formula (IV-1) | 5 | 10 | | 7 |
| 3-Cy-Cy-V | Formula (I) | 20 | 15 | 20 | 18 |
| 3-Cy-Cy-V1 | Formula (IV-1) | 12 | 8 | 10 | 8 |
| 3-Ph—Ph—2V1 | Formula (IV-3) | | | 5 | |
| 3-Cy-Ph—Ph-2 | Formula (IV-5) | | 5 | | |
| V-Cy-Ph—Ph-3 | Formula (IV-5) | | | 5 | |
| 3-Cy-1O—Ph5—O2 | Formula (Ia-2) | | | | 10 |
| 1V-Cy-1O—Ph5—O2 | Formula (Ia-2) | | | | 7 |
| 3-Cy-Ph5—O2 | Formula (Id-1) | 14 | 9 | 14 | |
| 5-Cy-Ph5—O2 | Formula (Id-1) | 6 | | 6 | |
| 3-Ph—Ph5—O2 | Formula (Id-2) | | 10 | | |
| 3-Cy-Cy-1O—Ph5—O2 | Formula (Ia-5) | | | | 8 |
| V-Cy-Cy-1O—Ph5—O2 | Formula (Ia-5) | | | | 5 |
| 1V-Cy-Cy-1O—Ph5—O2 | Formula (Ia-5) | | | | 5 |
| 3-Cy-Cy-Ph5—O2 | Formula (Id-4) | 12 | | 8 | |
| 5-Cy-Cy-Ph5—O2 | Formula (Id-4) | | 7 | | |
| 1V-Cy-Cy-Ph5—O2 | Formula (Id-4) | | | 6 | |
| 2-Cy-Ph—1O—Ph5—O2 | Formula (Id-3) | 5 | 10 | 6 | |
| 3-Cy-Ph—1O—Ph5—O2 | Formula (Id-3) | 9 | 10 | 10 | |
| 3-Ph—Ph5—Ph-2 | Formula (Id-6) | 13 | 5 | 4 | |
| V2—Ph—Ph5—Ph—2V | Formula (Id-6) | | | | 14 |
| V2—Ph—Ph5—Ph-2 | Formula (Id-6) | | | | 8 |
| Polymerizable compound | Formula (M1-3) | 0.4 | 0.4 | 0.4 | 0.4 |
| | Total | 100.4 | 100.4 | 100.4 | 100.4 |
| Physical properties | T_{NI} [° C.] | 76.1 | 76.5 | 75.0 | 75.9 |
| | Δn [—] | 0.108 | 0.108 | 0.108 | 0.108 |
| | Δε [—] | −3.1 | −3.1 | −3.0 | −3.1 |
| | γ₁ [mPa · s] | 106 | 100 | 103 | 83 |
| | K₃₃ [pN] | 12.3 | 12.5 | 13.1 | 14.8 |
| | γ₁/K₃₃ [mPa · s · pN⁻¹] | 8.6 | 8.0 | 7.9 | 5.6 |
| Tilt angle [°] | Initial | 86.7 | 86.3 | 87.1 | 87.3 |
| | After PSA | 84.2 | 83.6 | 84.7 | 85.3 |
| | Induced tilt angle | 2.5 | 2.7 | 2.4 | 2.0 |

Each of these polymerizable-compound-containing liquid crystal compositions was injected by vacuum injection into an ITO-provided cell having a cell gap of 3.5 μm and including polyimide alignment films used for inducing homeotropic alignment and subjected to rubbing. This cell was irradiated with UV at a radiation intensity of 100 mW/cm² on the surface of the cell with a high pressure mercury lamp via a filter used for cutting off ultraviolet having a wavelength of not more than 320 nm under application of a square wave of 5.0 V at a frequency of 1 kHz, thereby producing a vertical-alignment liquid crystal display device (PSA cell) in which the polymerizable compound in the polymerizable-compound-containing liquid crystal composition had been polymerized. The pretilt angle was measured to determine alignment-regulating force of the polymerizable compound on the liquid crystal compound. The pretilt angle was measured at 25° C. with TBA105 manufactured by AUTRONIC-MELCHERS GmbH.

In each of the polymerizable-compound-containing liquid crystal compositions LC-3, LC-4, LC-5, and LC-6 of the present invention, the irradiation with UV of 50 [J] gave an appropriate pretilt angle of approximately 2°, and γ₁/K₃₃ was sufficiently small. These PSA cells each had a high contrast and were able to quickly respond.
These results showed that the polymerizable compounds in the polymerizable-compound-containing liquid crystal compositions LC-3, LC-4, LC-5, and LC-6 of the present invention each had a sufficiently higher response speed and enabled production of a PSA cell having an excellent quality as compared with the LC-A as Comparative Example 1 and the LC-B as Comparative Example 2, regardless of a change in components.

Accordingly, the polymerizable-compound-containing liquid crystal compositions of the present invention enabled control of a pretilt angle that affects display qualities, such as quick response and high contrast, and allowed defective display, such as uneven display and screen burn-in, to be eliminated or significantly reduced.

### Examples 7 to 12

In order to research a variation based on a change in the type of monomer, polymerizable-compound-containing liquid crystal compositions LC-7 (Example 7), LC-8 (Example 8), LC-9 (Example 9), LC-10 (Example 10), LC-11 (Example 11), and LC-12 (Example 12) were prepared, in which the liquid crystal composition of Example 2 was used as a host liquid crystal composition LCX and in which a variety of monomers were individually used; and the physical properties thereof were measured. Table 3 shows the components and physical properties of the polymerizable-compound-containing liquid crystal compositions.

TABLE 3

| | | | | | | Example | Example | Example |
|---|---|---|---|---|---|---|---|---|
| | | | Example 7 | Example 8 | Example 9 | 10 | 11 | 12 |
| | | LCX | LC-7 | LC-8 | LC-9 | LC-10 | LC-11 | LC-12 |
| 3-Cy-Cy-2 | Formula (IV-1) | 2 | — | — | — | — | — | — |
| 3-Cy-Cy-4 | Formula (IV-1) | 8 | — | — | — | — | — | — |
| 3-Cy-Cy-V | Formula (I) | 20 | — | — | — | — | — | — |
| 3-Cy-Ph-O1 | Formula (IV-2) | 4 | — | — | — | — | — | — |
| 3-Ph-Ph-1 | Formula (IV-3) | 9 | — | — | — | — | — | — |
| 3-Cy-Cy-Ph-1 | Formula (IV-4) | 4 | — | — | — | — | — | — |
| 3-Cy-1O-Ph5-O2 | Formula (Ia-2) | 11 | — | — | — | — | — | — |
| 2-Cy-Cy-1O-Ph5-O2 | Formula (Ia-5) | 6 | — | — | — | — | — | — |
| 3-Cy-Cy-1O-Ph5-O2 | Formula (Ia-5) | 10 | — | — | — | — | — | — |
| 3-Cy-Ph-1O-Ph5-O3 | Formula (Id-3) | 7 | — | — | — | — | — | — |
| 3-Cy-Ph-1O-Ph5-O4 | Formula (Id-3) | 8 | — | — | — | — | — | — |
| 4-Cy-Ph-1O-Ph5-O3 | Formula (Id-3) | 6 | — | — | — | — | — | — |
| 3-Ph-Ph5-Ph-2 | Formula (Id-6) | 5 | — | — | — | — | — | — |
| LCX | Liquid crystal | — | 100 | 100 | 100 | 100 | 100 | 100 |
| | composition | | | | | | | |
| Polymerizable | Formula (M1-1) | — | 0.4 | — | — | — | — | — |
| compound | Formula (M1-3) | — | — | 0.2 | 0.2 | 0.2 | 0.35 | — |
| | Formula (M1-11) | — | — | 0.2 | — | — | — | — |
| | Formula (M2-4) | — | — | — | 0.2 | — | — | — |
| | Formula (M4-7) | — | — | — | — | 0.2 | 0.05 | — |
| | Formula (M302) | — | — | — | — | — | — | 0.4 |
| | Total | 100 | 100.4 | 100.4 | 100.4 | 100.4 | 100.4 | 100.4 |
| Physical properties | T_{NI} [° C.] | 76.0 | 76.1 | 76.1 | 76.1 | 76.3 | 76.2 | 75.8 |
| | Δn [—] | 0.109 | 0.109 | 0.109 | 0.109 | 0.109 | 0.109 | 0.109 |
| | Δε [—] | −3.1 | −3.1 | −3.1 | −3.1 | −3.1 | −3.1 | −3.1 |
| | γ₁ [mPa · s] | 108 | 112 | 111 | 112 | 112 | 112 | 110 |
| | K₃₃ [pN] | 13.0 | 13.1 | 13.0 | 13.1 | 13.2 | 13.2 | 13.1 |
| | γ₁/K₃₃ [mPa · s · pN⁻¹] | 8.3 | 8.5 | 8.5 | 8.5 | 8.5 | 8.5 | 8.4 |
| Tilt angle [°] | Initial | — | 87.1 | 87.2 | 87.0 | 87.2 | 87.1 | 87.2 |
| | After PSA | — | 84.3 | 85.3 | 85.0 | 85.1 | 85.2 | 84.0 |
| | Induced tilt angle | — | 2.8 | 1.9 | 2.0 | 2.1 | 1.9 | 3.2 |

Each of these polymerizable-compound-containing liquid crystal compositions was injected by vacuum injection into an ITO-provided cell having a cell gap of 3.5 m and including polyimide alignment films used for inducing homeotropic alignment and subjected to rubbing. This cell was irradiated with UV at a radiation intensity of 100 mW/cm² on the surface of the cell with a high pressure mercury lamp via a filter used for cutting off ultraviolet having a wavelength of not more than 320 nm under application of a square wave of 5.0 V at a frequency of 1 kHz, thereby producing a vertical-alignment liquid crystal display device (PSA cell) in which the polymerizable compound in the polymerizable-compound-containing liquid crystal composition had been polymerized. The pretilt angle was measured to determine alignment-regulating force of the polymerizable compound on the liquid crystal compound. The pretilt angle was measured at 25° C. with TBA105 manufactured by AUTRONIC-MELCHERS GmbH.

In each of the polymerizable-compound-containing liquid crystal compositions LC-7, LC-8, LC-9, LC-10, LC-11, and LC-12 of the present invention, the irradiation with UV of 50 [J] gave an appropriate pretilt angle of approximately 20 or more, and γ₁/K₃₃ was sufficiently small. These PSA cells each had a high contrast and were able to quickly respond.
These results showed that the polymerizable compounds in the polymerizable-compound-containing liquid crystal compositions LC-7, LC-8, LC-9, LC-10, LC-11, and LC-12 of the present invention each had a sufficiently higher response speed and enabled production of a PSA cell having an excellent quality as compared with the LC-A as Comparative Example 1 and the LC-B as Comparative Example 2, regardless of a change in the type of monomer.

Accordingly, the polymerizable-compound-containing liquid crystal compositions of the present invention enabled control of a pretilt angle that affects display qualities, such as quick response and high contrast, and allowed defective display, such as uneven display and screen burn-in, to be eliminated or significantly reduced.

### Examples 13 and 14

Polymerizable-compound-containing liquid crystal compositions LC-13 (Example 13) and LC-14 (Example 14) were prepared, and the physical properties thereof were measured. Table 4 shows the components and physical properties of the polymerizable-compound-containing liquid crystal compositions.

TABLE 4

| | | Example 13 | Example 14 |
|---|---|---|---|
| | | LC-13 | LC-14 |
| 3-Cy-Cy-2 | Formula (IV-1) | | 18.5 |
| 3-Cy-Cy-5 | Formula (IV-1) | 5 | |
| 3-Cy-Cy-V | Formula (I) | 24 | 15 |
| 3-Cy-Cy-V1 | Formula (IV-1) | 10 | |
| 3-Cy-Ph—O1 | Formula (IV-2) | | 4 |
| 3-Ph—Ph-1 | Formula (IV-3) | 6 | 8 |
| 1V-Cy-Ph—Ph-3 | Formula (IV-5) | | 5 |
| 3-Cy-1O—Ph5—O2 | Formula (Ia-2) | 11 | 4 |
| 1V-Cy-1O—Ph5—O2 | Formula (Ia-2) | | 5 |
| 1V-Cy-1O—Ph5—O4 | Formula (Ia-2) | | 4 |
| 2-Cy-Cy-1O—Ph5—O2 | Formula (Ia-5) | 12 | |
| 3-Cy-Cy-1O—Ph5—O2 | Formula (Ia-5) | 12 | |
| 4-Cy-Cy-1O—Ph5—O2 | Formula (Ia-5) | 3 | |
| 1V-Cy-Cy-1O—Ph5—O2 | Formula (Ia-5) | | 9 |
| 1V-Cy-Cy-1O—Ph5—O3 | Formula (Ia-5) | | 9.5 |
| 2-Cy-Ph—1O—Ph5—O2 | Formula (Id-3) | | 7 |
| 3-Cy-Ph—1O—Ph5—O2 | Formula (Id-3) | | 8 |
| 3-Ph—Ph5—Ph-1 | Formula (Id-6) | 5 | |
| 3-Ph—Ph5—Ph-2 | Formula (Id-6) | 12 | |
| 3-Np-Ph5—Ph-2 | Formula (Np-1) | | 3 |
| Polymerizable compound | Formula (M302) | 0.4 | 0.4 |
| | Total | 100.4 | 100.4 |
| Physical properties | T_{NI} [° C.] | 75.8 | 75.0 |
| | Δn [—] | 0.108 | 0.108 |
| | Δε [—] | −3.2 | −3.0 |
| | γ₁ [mPa · s] | 101 | 115 |
| | K₃₃ [pN] | 14.7 | 14.4 |
| | γ₁/K₃₃ [mPa · s · pN⁻¹] | 6.9 | 8.0 |
| Tilt angle [°] | Initial | 86.9 | 87.1 |
| | After PSA | 84.5 | 83.0 |
| | Induced tilt angle | 2.4 | 4.1 |

Each of these polymerizable-compound-containing liquid crystal compositions was injected by vacuum injection into an ITO-provided cell having a cell gap of 3.5 μm and including polyimide alignment films used for inducing homeotropic alignment and subjected to rubbing. This cell was irradiated with UV at a radiation intensity of 100 mW/cm² on the surface of the cell with a high pressure mercury lamp via a filter used for cutting off ultraviolet having a wavelength of not more than 320 nm under application of a square wave of 5.0 V at a frequency of 1 kHz, thereby producing a vertical-alignment liquid crystal display device (PSA cell) in which the polymerizable compound in the polymerizable-compound-containing liquid crystal composition had been polymerized. The pretilt angle was measured to determine alignment-regulating force of the polymerizable compound on the liquid crystal compound. The pretilt angle was measured at 25° C. with TBA105 manufactured by AUTRONIC-MELCHERS GmbH.

In each of the polymerizable-compound-containing liquid crystal compositions LC-13 and LC-14 of the present invention, the irradiation with UV of 50 [J] gave an appropriate pretilt angle of 2° or more, and γ₁/K₃₃ was sufficiently small. These PSA cells each had a high contrast and were able to quickly respond.
These results showed that the polymerizable compounds in the polymerizable-compound-containing liquid crystal compositions LC-13 and LC-14 of the present invention each had a sufficiently higher response speed and enabled production of a PSA cell having an excellent quality as compared with the LC-A as Comparative Example 1 and the LC-B as Comparative Example 2, regardless of a change in in the type of monomer.

Accordingly, the polymerizable-compound-containing liquid crystal compositions of the present invention enabled control of a pretilt angle that affects display qualities, such as quick response and high contrast, and allowed defective display, such as uneven display and screen burn-in, to be eliminated or significantly reduced.

1. A liquid crystal composition comprising a first component that is 5 mass % to 25 mass % of a compound represented by Formula (I), 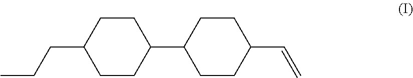 [SMILES: C=CC1CCC(C2CCC(CCC)CC2)CC1]
a second component that is at least one compound having a negative dielectric anisotropy (Δ∈) with an absolute value of greater than three and a structure represented by any of General Formulae (Ia) to (Ic) 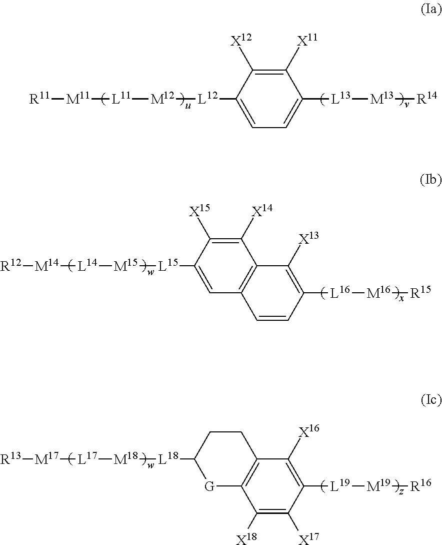
(where R¹¹, R¹², R¹³, R¹⁴, R¹⁵, and R¹⁶ each independently represent an alkyl group having 1 to 10 carbon atoms or an alkenyl group having 2 to 10 carbon atoms; in each of the alkyl and alkenyl groups, one methylene group or at least two methylene groups not adjoining each other are each independently optionally substituted with —O— or —S—, and at least one hydrogen atom is optionally substituted with a fluorine atom or a chlorine atom;
u, v, w, x, y and z each independently represent 0, 1, or 2 where u+v, w+x, and y+z are each equal to 2 or lower:
M¹¹, M¹², M¹³, M¹⁴, M¹⁵, M¹⁶, M¹⁷, M¹⁸, and M¹⁹ each independently represent a group selected from the group consisting of
(a) a trans-1,4-cyclohexylene group (of which one methylene group or at least two methylene groups not adjoining each other are optionally substituted with —O— or —S—),
(b) a 1,4-phenylene group (of which one —CH═ moiety or at least two —CH═ moieties not adjoining each other are each optionally substituted with a nitrogen atoms), and
(c) a 14-cyclohexenylene group, a 1,4-bicyclo(2.2.2)octylene group, a piperidine-2,5-diyl group, a naphthalene-2,6-diyl group, a 1,2,3,4-tetrahydronaphthalene-2,6-diyl group, and a decahydronaphthalene-2,6-diyl group; in each of the groups (a), (b), and (c), a hydrogen atom is optionally substituted with a cyano group, a fluorine atom, a trifluoromethyl group, a trifluoromethoxy group, or a chlorine atom: in the case where M¹², M¹³, M¹⁵, M¹⁶, M¹⁸, and M¹⁹ are multiple, the multiple M¹²'s, M¹³'s, M¹⁵'s, M¹⁶'s, M¹⁸'s, and M¹⁹'s may be individually the same as or different from each other;
L¹¹, L¹², L¹³, L¹⁴, L¹⁵, L¹⁶, L¹⁷, L¹⁸, and L¹⁹ each independently represent a single bond, —COO—, —OCO—, —CH₂CH₂—, —(CH₂)₄—, —OCH₂—, —CH₂O—, —OCF₂—, —CF₂O—, or —C≡C—; in the case where L¹¹, L¹³, L¹⁴, L¹⁶, L¹⁷, and L¹⁹ are multiple, the multiple L¹¹'s, L¹³'s, L¹⁴'s, L¹⁶'s, L¹⁷'s, and L¹⁹'s may be individually the same as or different from each other; at least one of L¹¹, L¹², and L¹³ present in the structure does not represent a single bond; at least one of L¹⁴, L¹⁵, and L¹⁶ present in the structure does not represent a single bond; and at least one of L¹⁷, L¹⁸, and L¹⁹ present in the structure does not represent a single bond;
X¹¹ and X¹² each independently represent a trifluoromethyl group, a trifluoromethoxy group, or a fluorine atom; X¹³, X¹⁴, X¹⁵, X¹⁶, X¹⁷, and X¹⁸ each independently represent a hydrogen atom, a trifluoromethyl group, a trifluoromethoxy group, or a fluorine atom; any one of X¹¹ and X¹² represents a fluorine atom; any one of X¹³, X¹⁴, and X¹⁵ represents a fluorine atom; any one of X¹⁶, X¹⁷, and X¹⁸ represents a fluorine atom: each of X¹⁶ and X¹⁷ does not represent a fluorine atom at the same time; each of X¹⁶ and X¹⁸ does not represent a fluorine atom at the same time; and G represents a methylene group or —O—), and
a third component that is at least one polymerizable compound having at least one polymerizable functional group.

2. The liquid crystal composition according to claim 1, wherein at least one compound represented by General Formula (Id) is used as the second component 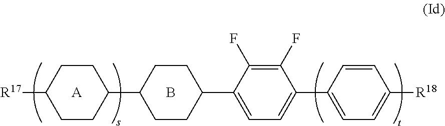
(where R¹⁷ and R¹⁸ each independently represent an alkyl group having 1 to 10 carbon atoms or an alkenyl group having 2 to 10 carbon atoms; in each of the alkyl and alkenyl groups, one methylene group or at least two methylene groups not adjoining each other are each optionally substituted with —O— or —S—, and at least one hydrogen atom is optionally substituted with a fluorine atom or a chlorine atom;
s and t are each independently from 0 to 2, and s+t is equal to 2 or lower; and rings A and B each independently represent a trans-1,4-cyclohexylene group, a 1,4-phenylene group, a 1,4-cyclohexenylene group, a 1,4-bicyclo(2.2.2)octylene group, a naphthalene-2,6-diyl group, a 1,2,3,4-tetrahydronaphthalene-2,6-diyl group, or a decahydronaphthalene-2,6-diyl group).

3. The liquid crystal composition according to claim 2, wherein one or more compounds selected from the group consisting of the compounds represented by General Formulae (Ia) and (Id) are used as the second component, and the total amount of the selected compounds is in the range of 90 to 100 mass % relative to the amount of the whole second component.

4. The liquid crystal composition according to claim 1, wherein the compound represented by General Formula (Ia) is any of compounds represented by Formulae (Ia-1) to (Ia-6) 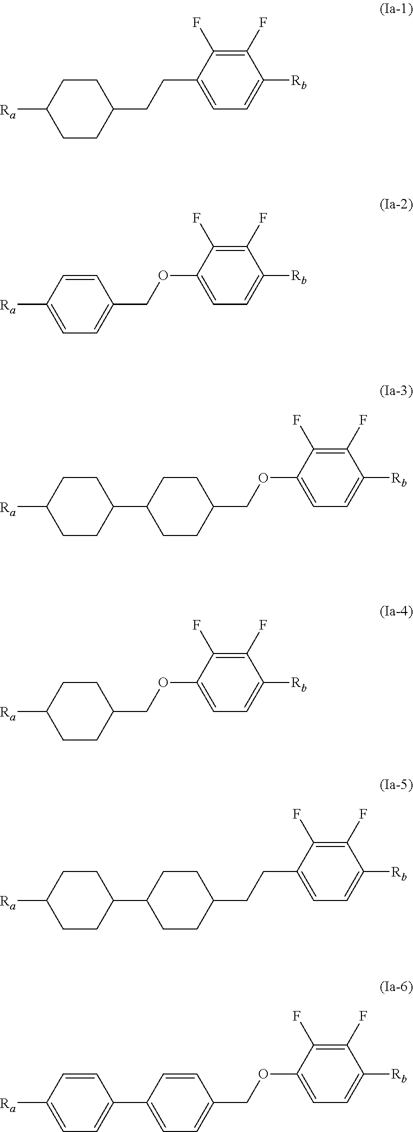
(where Rₐ and R_{b} each independently represent an alkyl group having 1 to 7 carbon atoms, an alkoxy group having 1 to 7 carbon atoms, an alkenyl group having 2 to 6 carbon atoms, or an alkenyloxy group having 2 to 6 carbon atoms; and in each of these alkyl, alkenyl, alkoxy, and alkenyloxy groups, at least one methylene group is optionally substituted with an oxygen atom provided that oxygen atoms are not bonded to each other in sequence, and at least one hydrogen atom is optionally substituted with a fluorine atom).

5. The liquid crystal composition according to claim 1, wherein the polymerizable compound is a compound represented by General Formula (II) 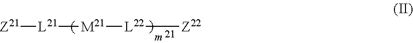
(where Z²¹ and Z²² each independently represent the following structure; 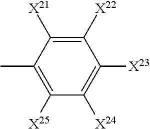
X²¹ to X²⁵ each represent a hydrogen atom, a fluorine atom, or the following structure;
—S²¹—R²¹
at least one of X²¹ to X²⁵ in each of Z²¹ and Z²² is the following structure;
—S²¹—R²¹
S²¹ represents an alkyl group having 1 to 12 carbon atoms or a single bond, and a methylene group of the alkyl group is optionally substituted with an oxygen atom, —COO—, —OCO—, or —OCOO— provided that oxygen atoms are not directly bonded to each other: R²¹ represents any of the following structures represented by Formulae (R-1) to (R-15); 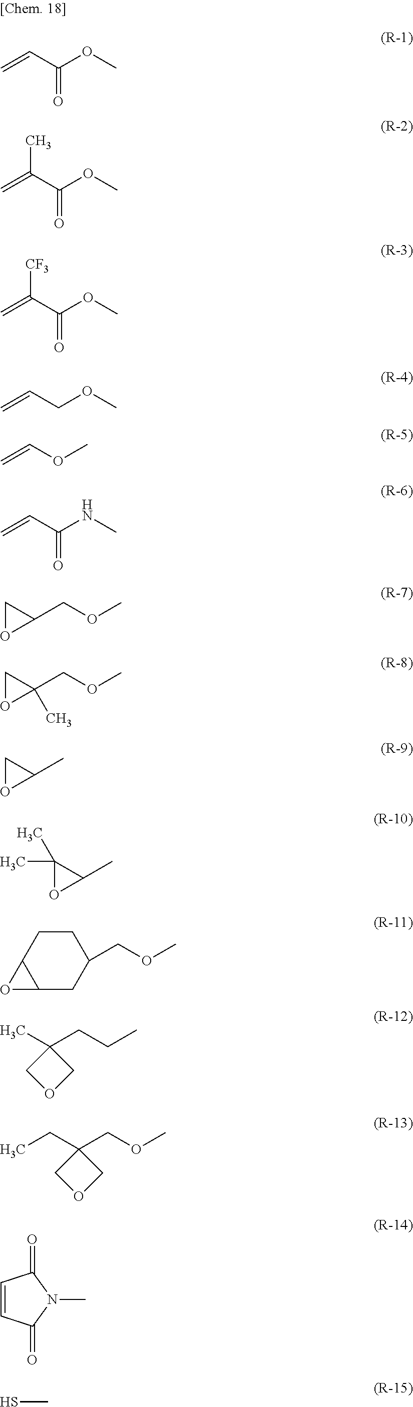
in the case where S²¹ and R²¹ are multiple, the multiple S²¹'s may be the same as or different from each other, and the multiple R²¹'s may be the same as or different from each other; L²¹ and L²² each independently represent a single bond, —O—, —CH₂—, —OCH₂—, —CH₂O—, —CO—, —C₂H₄—, —COO—, —OCO—, —CH═CH—COO—, —COO—CH═CH— —OCO—CH═CH—, —CH═CH—OCO—, —COOC₂H₄—, —OCOC₂H₄—, —C₂H₄OCO—, —C₂H₄COO—, —OCOCH₂—, —CH₂COO—, —CH═CH—, —CF═CH—, —CH═CF—, —CF═CF—, —CF₂—, —CF₂O—, —OCF₂—, —CF₂CH₂—, —CH₂CF₂—, —CF₂CF₂—, or —C≡C—: in the case where L²² is multiple, the multiple L²²'s may be the same as or different from each other; M²¹ independently represents a 1,4-phenylene group, a 1,4-cyclohexylene group, or a naphthalene-2,6-diyl group and is independently optionally unsubstituted or subjected to substitution of a hydrogen atom with a fluorine atom, a chlorine atom, an alkyl group having 1 to 8 carbon atoms, a halogenated alkyl group having 1 to 8 carbon atoms, a halogenated alkoxy group having 1 to 8 carbon atoms, an alkoxy group having 1 to 8 carbon atoms, a nitro group, or the following structure;
—S²¹—R²¹
in the case where M²¹ is multiple, the multiple M²¹'s may be the same as or different from each other; and m²¹ represents 0, 1, or 2).

6. The liquid crystal composition according to claim 5, wherein R²¹ in General Formula (II) is represented by (R-1) and/or (R-2).

7. The liquid crystal composition according to claim 6, further comprising a fourth component that is 5 to 70 mass % of at least one compound represented by General Formula (IV) 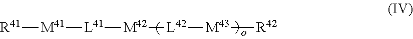
(where R⁴¹ and R⁴² each independently represent an alkyl group having 1 to 10 carbon atoms or an alkenyl group having 2 to 10 carbon atoms: in each of the alkyl and alkenyl groups, one methylene group or at least two methylene groups not adjoining each other are each optionally substituted with —O— or —S—, and at least one hydrogen atom is optionally substituted with a fluorine atom or a chlorine atom;
o represents 0, 1, or 2;
M⁴¹, M⁴², and M⁴³ each independently represent a group selected from the group consisting of
(d) a trans-1,4-cyclohexylene group (of which one methylene group or at least two methylene groups not adjoining each other are optionally substituted with —O— or —S—),
(e) a 1,4-phenylene group (of which one —CH═ moiety or at least two —CH═ moieties not adjoining each other are optionally substituted with a nitrogen atom), a 3-fluoro-1,4-phenylene group, or a 3,5-difluoro-1,4-phenylene group, and
(f) a 1,4-cyclohexenylene group, a 1,4-bicyclo(2.2.2)octylene group, a piperidine-2,5-diyl group, a naphthalene-2,6-diyl group, a decahydronaphthalene-2,6-diyl group, and a 1,2,3,4-tetrahydronaphthalene-2,6-diyl group; in the case where M⁴³ is multiple, the multiple M⁴³'s may be the same as or different from each other; L⁴¹ and L⁴² each independently represent a single bond, —CH₂CH₂—, —(CH₂)₄—, —OCH₂—, —CH₂O—, —OCF₂—, —CF₂O—, —CH═CH—, —CH═N—N═CH—, or —C≡C—; in the case where L⁴ is multiple, the multiple L⁴²'s may be the same as or different from each other; and the compound represented by General Formula (IV) excludes the compound represented by Formula (I)).

8. The liquid crystal composition according to claim 7, wherein the compound represented by General Formula (IV) as the fourth component is any of compounds represented by General Formulae (IV-1) to (IV-6) 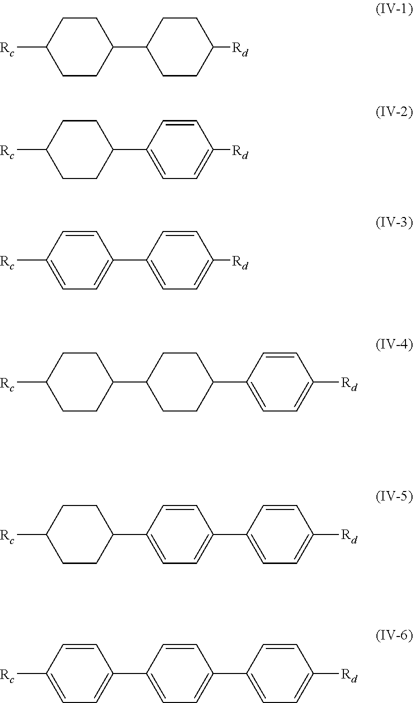
(where R_{c} and R_{d} each independently represent an alkyl group having 1 to 7 carbon atoms, an alkoxy group having 1 to 7 carbon atoms, an alkenyl group having 2 to 6 carbon atoms, or an alkenyloxy group having 2 to 6 carbon atoms; in each of these alkyl, alkenyl, alkoxy, and alkenyloxy groups, at least one methylene group is optionally substituted with an oxygen atom provided that oxygen atoms are not bonded to each other in sequence, and at least one hydrogen atom is optionally substituted with a fluorine atom: and the compound represented by Formula (IV-1) excludes the compound represented by Formula (I)), and the amount of the compound to be used is in the range of 90 to 100 mass % relative to the amount of the whole fourth component.

9. A liquid crystal display device comprising the liquid crystal composition containing the polymerizable compound according to claim 1, wherein the polymerizable compound in the liquid crystal composition is polymerized to enable alignment of liquid crystal molecules.

10. A liquid crystal display comprising the liquid crystal device according to claim 9.
